(19) United States
(12) Patent Application Publication
(10) Pub. No.: US 2005/0125674 A1
(43) Pub. Date: Jun. 9, 2005

(54) Authentication control system and authentication control method

(76) Inventors: Kenya Nishiki, Chigasaki (JP); Masayuki Sakata, Ebina (JP)

Correspondence Address: Mattingly, Stanger & Malur, P.C., Suite 370, 1800 Diagonal Road, Alexandria, VA, 22314, US

(21) Appl. No.: 10/893,908

(22) Filed: Jul. 20, 2004

(30) Foreign Application Priority Data
Dec. 9, 2003 (JP) 2003-410397

(51) Int. Cl. H04L 9/00

(52) U.S. Cl. 713/182

(57) ABSTRACT

A method for authenticating a room entering person who tries to enter an area where one or more structural elements are present is determined by employing a hardware token storing attribute information of the person. A security level of each of the structural elements presently located within the area is acquired via network. The attribute information of the person is acquired from the hardware token. A present security level of the area is determined by employing the security levels of the structural elements. A present trust level of the person is determined by employing the attribute information of the person. An authenticating method of the person is determined in a manner that at least one authenticating method is selected from plural authenticating methods by employing the determined present security level of the area and the determined present trust level of the person.

### INCORPORATION BY REFERENCE

The present application claims priority from Japanese application JP2003-410397 filed on Dec. 9, 2003, the content of which is hereby incorporated by reference into this application.

### BACKGROUND OF THE INVENTION

The present invention relates to both an authentication control system and an authentication control method. More specifically, the present invention is directed to such an authentication control system and an authentication control method, capable of authenticating users in a proper level, who are trying to enter into an area within the authentication control system even under such an environment that security and reliability of this system are changed as structural elements provided in the area are varied.

Very recently, since mobility of labors is advanced, there are many opportunities that many persons other than staff members of offices go into the offices and also come out from the offices, and these persons may access information processing appliances and also network appliances installed in these offices. Also, while an unspecified number of users can utilize network services without any restriction as to temporal elements and locations, these users can remote-access outside the offices via public service networks to internal systems of these offices under such a circumstance, the following problem may occur. That is to say, while these users do not always pay their specific attentions to security, they utilize the internal systems of the offices. Therefore, there is a great possibility that unfair uses of the internal systems by persons who own bad willings are permitted due to careless operations of these users.

To more firmly execute user authenticating operations, several authenticating technical ideas with employment of physical features have been proposed. As one of these technical ideas, JP-A-2001-052181 has described such an authentication system that results of plural authenticating methods by employing plural sorts of physical features have been previously stored in a table, and then, authenticating operations are carried out, while these plural authenticating methods are switched in the preset order until a user may be authenticated.

However, since a total number of terminals which use networks is rapidly increased as well as a total number of used services is considerably increased, it is desirable to previously set the authentication of the users. Furthermore, it is preferable to realize a mode of so-called “single sign-on”, namely a plurality of services may be utilized after a user is once authenticated.

### SUMMARY OF THE INVENTION

Therefore, an object of the present invention is to provide both an authentication control system and an authentication control method, which are capable of authenticating a user in a proper level, who is trying to enter an area defined in the authentication control system, even under such an environment that security and reliability of this authentication control system are changed as a structural element provided in this area is varied.

### BRIEF DESCRIPTION OF THE DRAWINGS

FIG. 1 is a schematic diagram for showing an arrangement of an internal network system of a building to which an authentication control system of an embodiment of the present invention has been applied.

FIG. 2 is a schematic diagram for showing an internal arrangement of an authentication control apparatus 60 employed in the internal network system of FIG. 1.

FIG. 3 is a diagram for representing an example of registered contents of an area information management table (TBL) storage unit 611 employed in the internal network system of FIG. 1.

FIG. 4A to FIG. 4C are diagrams for indicating an example of registered contents of a security level management TBL storage unit 610 employed in the internal network system of FIG. 1.

FIG. 5A to FIG. 5C are diagrams for indicating an example of registered contents of a trust level management TBL storage unit 612 employed in the internal network system of FIG. 1.

FIG. 6 is a diagram for representing an example of registered contents of an authentication level management table (TBL) storage unit 613 employed in the internal network system of FIG. 1.

FIG. 7 is a diagram for representing an example of registered contents of an authenticating method management table storage unit 615 employed in the internal network system of FIG. 1.

FIG. 8 is an explanatory diagram for explaining an example of an authentication ticket used in the internal network system of FIG. 1.

FIG. 9 is an explanatory diagram for explaining an example of an access ticket used in the internal network system of FIG. 1.

FIG. 10 is a diagram for showing a hardware structural example of the authentication control apparatus 60.

FIG. 11 is a flowchart for describing an issuing process operation of the authentication ticket of the authentication apparatus 60.

FIG. 12 is a flowchart for describing an issuing process operation of the access ticket of the authentication apparatus 60.

FIG. 13 is a schematic diagram for showing an internal arrangement of an authentication apparatus 50 employed in the internal network system of FIG. 1.

FIG. 14 is a diagram for representing an example of registered contents of an authentication information database (DB) 503 employed in the internal network system of FIG. 1.

FIG. 15 is a flowchart for explaining an authentication process operation of the authentication apparatus 50.

FIG. 16 is a schematic diagram for indicating an internal structure of an HT (hardware token) 90 used in the internal network system of FIG. 1.

FIG. 17 is a flowchart for explaining operations of the HT 90.

FIG. 18 is a schematic diagram for showing an internal arrangement of a user terminal 80 employed in the internal network system of FIG. 1.

FIG. 19 is a flowchart for explaining operations of the user terminal 80 shown in FIG. 18.

FIG. 20 is a diagram for illustratively indicating an example of a security policy setting acceptance view displayed on a display unit 804 of the user terminal 80.

FIG. 21 is a schematic diagram for showing one of electronic appliances which constitute a structural element 70 of the internal network system indicated in FIG. 1.

FIG. 22A to FIG. 22B are flowcharts for explaining operations of an access control unit 7013 of each of the electronic appliances which constitute the structural element 70.

FIG. 23 is a diagram for indicating flow operations of information, which are executed among the HT 90, the authentication control apparatus 60, and the authentication apparatus 50 when an authentication ticket is issued.

FIG. 24 is a diagram for indicating flow operations of information, which are executed among the HT 90, the authentication control apparatus 60, and the authentication apparatus 50 when an access ticket is issued.

FIG. 25 is a diagram for illustratively indicating an application example in which the authentication control method of the present invention is applied to an electronic conference room system.

### DESCRIPTION OF THE EMBODIMENTS

Referring now to drawings, various embodiments of the present invention will now be described.

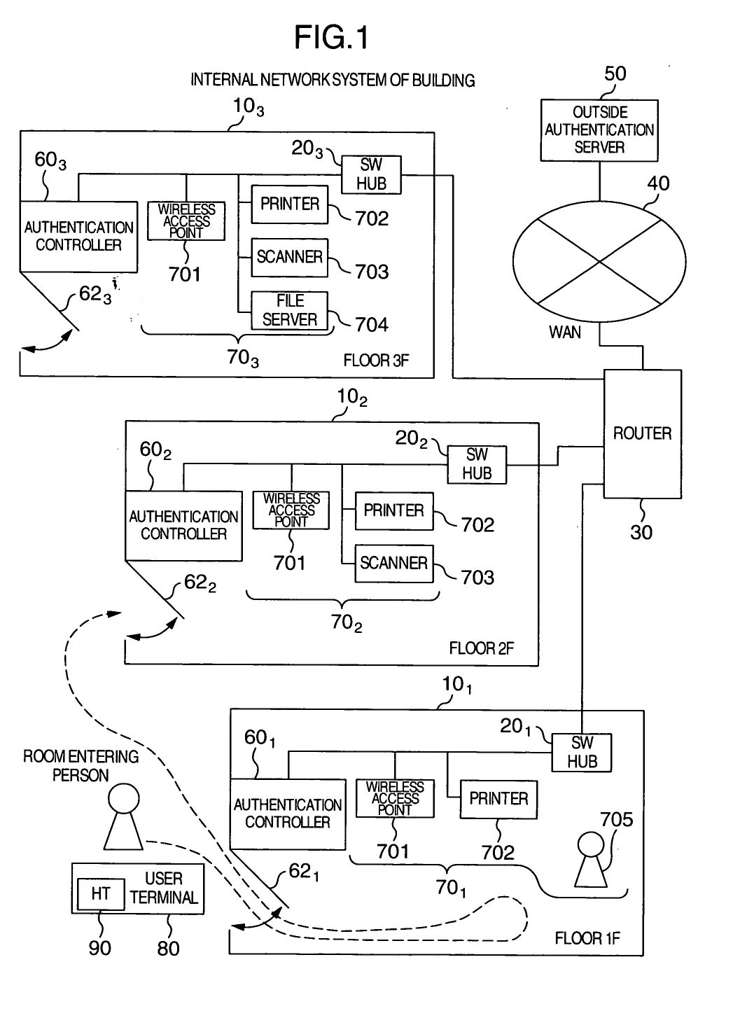

FIG. 1 is a schematic diagram for indicating an arrangement of an internal network system of a building which corresponds to an embodiment of an authentication control system, to which the present invention has been applied. As indicated in this drawing, the internal network system of the building according to this embodiment contains a plurality of room areas 10 as areas where the network is constructed within the building. In this drawing, a room area 101 (located on floor 1F), another room area 102 (located on floor 2F), and another room area 103 (located on floor 3F). The respective room areas 101 to 103 are mutually connected to each other by switching hubs (SWHUB) 20, to 203. Also, the internal network of the building is connected via both a router 30 and a WAN (Wide Area Network) 40 to an authentication apparatus 50 which performs a user authenticating operation.

The room area 10 contains both an authentication control apparatus 60 and a structural element 70, which are connected to each other via a network. In this embodiment, the room area 10₁ contains an authentication control apparatus 60₁ and structural or system elements 70₁; the room area 10₂ contains an authentication control apparatus 60₂ and structural elements 70₂; and the room area 10₃ contains an authentication control apparatus 60₃ and structural elements 70₃.

The authentication control apparatus 60 is directly communicated to a hardware token (HT) 90 which is owned by a user who is trying to enter the room area 10, or is communicated via a user terminal 80 into which the HT 90 has been inserted to the HT 90 so as to authenticate the user (a room entering person: for example, a maintenance engineer who investigates/maintains electronic appliance within each of room areas) in conjunction with the authentication apparatus 50. As will be explained later, an authenticating method executed at this time is determined by considering both a security level of a room area into which a room entering person is trying to enter, and a trust level of a person existing in the room area. The present invention is featured by that the security level of this room area is changed in response to both a security level which has been set with respect to each of electronic appliances installed within the room area, and a security level which has been set to a person (namely, a room existing person) who is present within the room area. In this case, it should be understood that the person (for example, reference numeral 705 of FIG. 1) who is present within the room area is also considered as the structural element within the room area. Another feature of the present invention is given as follows; That is, a trust level of a room entering person is changed in response to attributes of the room entering person, a room entering frequency of the room entering person who enters this room area, and an access place where the room entering person accesses this room area (in this specification, such a user who is trying to indirectly access from external area to a room area will also be called as “room entering person”).

Only in such a case that authentication of a room entering person can succeed, for instance, the authentication control apparatus 60 opens a gate (door) 62 installed at an entrance of the relevant room area 10, or performs an authentication control operation in order to allow the room entering person to enter this room area 10. Even in a case that a room entering person is allowed to enter a room area, a check is made as to whether or not an access operation by the user terminal 80 owned by the room entering person to each of electronic appliances within this room area 10 is permitted. In this case, as the electronic appliances which constitute the structural elements 70, a network appliance such as a wireless access point (AP) 701, a printer 702, a scanner, and a network terminal (information appliance) such as a file server 704 are provided.

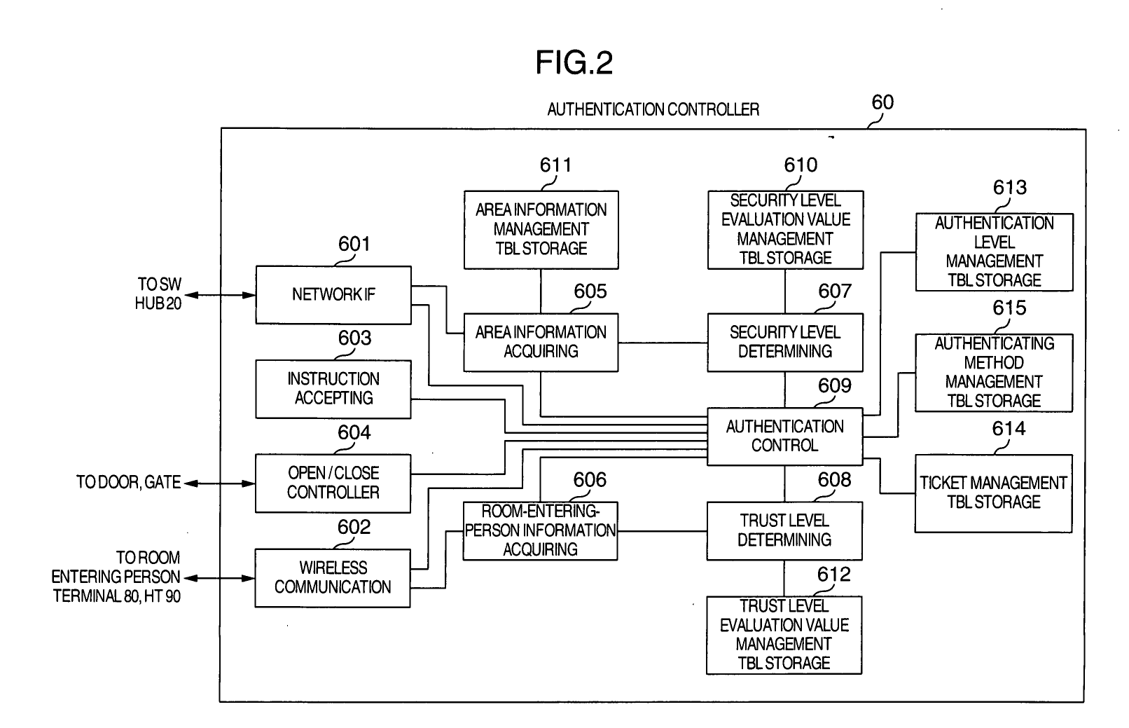

FIG. 2 is a schematic diagram for indicating an internal arrangement of the authentication control apparatus 60.

A network IF unit 601 is employed so as to be communicated to the respective electronic appliances (network appliance, information appliance) and the WAN 40, which constitute the internal network system of the building. This network IF unit 601 is connected via a network cable to the SWHUB 20.

A wireless communication unit 602 is communicated to both a room entering person's terminal 80 and/or the HT 90 by way of a short distance wireless communication manner such as an infrared communication manner.

An instruction accepting unit 603 is to display information with respect to user, and also to accept an input of the information. The instruction accepting unit 603 may be alternatively constructed of an input/output apparatus such as a touch panel, or may be alternatively constructed of an accepting terminal connected via the network IF unit 601.

An open/close control unit 604 controls opening/closing operations of either a door or a gate, which is provided at, for example, an entrance of the related room area 10. It should be understood that instead of providing of the open/close control unit 604, while an open/close control apparatus connected via the network IF unit 601 to the authentication control apparatus 60 is separately prepared, opening/closing operations of either the door or the gate may be alternatively controlled by this open/close control apparatus.

An area information acquiring unit 605 acquires attribute information indicative of a security level of each of electronic appliances via the network IF unit 601. These electronic appliances are the structural elements 70 which presently belongs to the related room area 10. Then, the area information acquiring unit 605 registers the acquired attribute information to an area information management table (TBL) storage unit 611. Also, the area information acquiring unit 605 adds, or deletes attribute information of a person (room existing person) who presently exists in the related room area 10 into, or from the area information management TBL storage unit 611. As described above, since an electronic appliance and/or a person, which are present in a room area, is added, or deleted, data which is registered in the area information management TBL storage unit 611 is changed. Furthermore, the area information acquiring unit 605 reads information which has been registered in the area information management TBL storage unit 611, and then, transmits the read information to a security level determining unit 607.

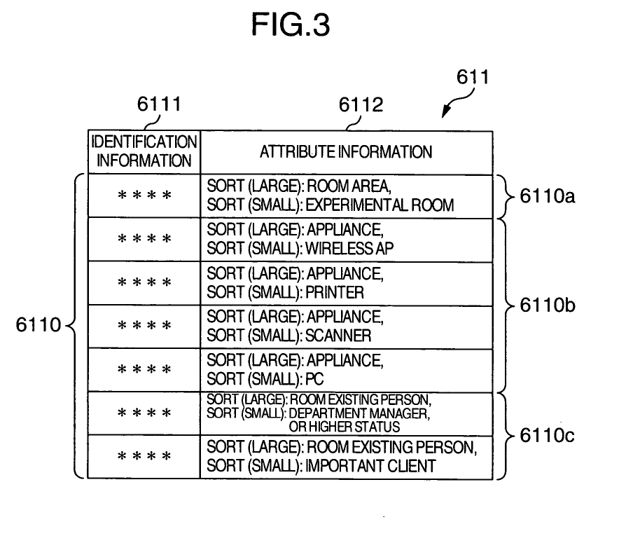

FIG. 3 is a diagram for indicating an example of contents which have been registered in the area information management TBL storage unit 611. As indicated in this drawing, in this registered contents example, a record 6110 is formed by employing a field 6111 and another field 6112. The field 6111 is used to register thereinto identification information for identifying a subject within the internal network system of the building. The field 6112 is used to register thereinto attribute information of the subject.

In this example, three sorts of records 6110 are registered in the area information management TBL storage unit 611, namely a record 6110a in which a subject corresponds to a room area; a record 6110b in which a subject corresponds to an electronic appliance which is one of the presently existing structural elements 70; and a record 6110c in which a subject corresponds to a room existing person who presently exists in the room area 10. The record 6110a corresponds to such a record that has been previously registered by the operator of the authentication control apparatus 60. The record 6110b corresponds to such a record that is registered/deleted by the area information acquiring unit 605 based upon the attribute information acquired from the respective structural appliances of the structural element 70. Then, the record 6110c corresponds to such a record that is registered/deleted by the area information acquiring unit 605 in accordance with an instruction of the authentication control unit 609.

In the field 6111 of the record 6110a, for example, a unique number selected by the operator of the authentication control apparatus 60 is registered as identification information. In the field 6111 of the record 6110b, an address (for example, IP address) of an electronic appliance equal to the structural element 70 is registered. Then, in the field 6111 of the record 6110c, a provisional ID used for an authentication ticket (will be explained later) is registered.

The attribute information which is registered in a field 6112 corresponds to such information (environment information) that constitutes an influence factor with respect to security of a room area. The attribute information contains information indicative of a rough sort (sort (large)) of a subject, and another information indicative of a detailed sort (sort (small)) in this rough sort. In the record 6110a, “room area” is registered as the information indicative of the sort (large), and a sort (attribute) of such an area as “acceptance”, “experimental room”, “reception room”, and “conference room.” In the record 6110b, “electronic appliance” is registered as the information indicative of the sort (large), and a sort (attribute) of the electronic appliance such as “wireless AP”, “file server”, “printer”, “scanner”, and “PC” is registered as the information indicative of the sort (small). Then, in the record 6110c, “room existing person” is registered as the information indicative of the sort (large), and status/belonging section (attribute) of the room existing person is registered as the information indicative of the sort (small). The status/belonging section of the room existing person is defined as “department manager, or higher status”, “section manager, or higher status”, “general staff member”, and “important client.”

A room-entering-person information acquiring unit 606 acquires attribute information (environment information) of this room entering person from either the user terminal 80 or the HT 90 via the wireless communication unit 602 in response to an instruction issued from the authentication control unit 609, while the attribute information constitutes an influence factor given to the reliability of the room entering person. Then, the room-entering-person information acquiring unit 606 transmits the acquired attribute information of the room entering person to a trust level determining unit 608. As attribute information of a room entering person, the following information is given, namely, a user ID corresponding to identification information of a room entering person; a status (general staff member, division manager, section manager, department manager, temporary staff member, person other than company or the like) of a room entering person; a belonging section (belonging department/section or the like) of a room entering person; a use frequency (everyday, 4 to 6 days per week, 1 to 3 days per week, or less than 1 day per week) of an internal network system of a building; and a place where a room entering person accesses (entrance, place inside a company, public network (portable telephone network), public network (wireless LAN) or the like).

The security level determining unit 607 determines a security level of the relevant room area 10 by employing both information which has been registered in the security level management TBL storage unit 610 and information which has been read from the area information management TBL storage unit 611 via the area information acquiring unit 605. Then, the security level determining unit 607 transmits the determined security level to the authentication control unit 609.

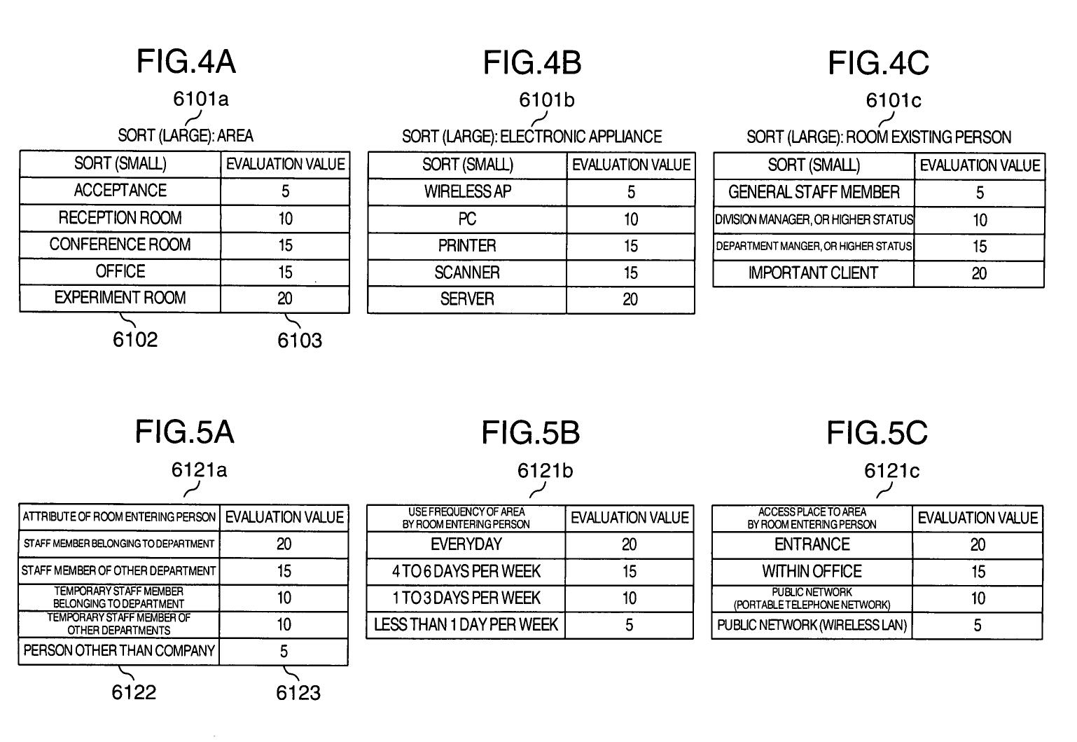

FIG. 4A to FIG. 4C illustratively show an example of registered contents of the security level management TBL storage unit 610. FIG. 4A indicates a table 6101a which is used to determine an evaluation value of the record 6110a of the area information management TBL storage unit 611 into which “room area” has been registered as the information of the sort (large). The evaluation value implies such a numeral value for evaluating how degree security must be made up. FIG. 4B indicates a table 6101b which is used to determine an evaluation value of the record 6110b of the area information management TBL storage unit 611 into which “electronic appliance” has been registered as the information of the sort (large). FIG. 4C indicates a table 6101c which is used to determine an evaluation value of the record 6110c of the area information management TBL storage unit 611 into which “room entering person” has been registered as the information of the sort (large). Evaluation values 6103 of information 6102 have been registered into the respective tables 6101a to 6101c every information 6102 of the sort (small).

The security level determining unit 607 specifies such an evaluation value corresponding to the information of the sort (small) of the record 6110a read out from the area information management TBL storage unit 611 by employing the table 6101a shown in FIG. 4A. Similarly, the security level determining unit 607 specifies such an evaluation value corresponding to the information of the sort (small) of the each record 6110b read out from the area information management TBL storage unit 611 by employing the table 6101b shown in FIG. 4B. Also, the security level determining unit 607 specifies such an evaluation value corresponding to the information of the sort (small) of the each record 6110c read out from the area information management TBL storage unit 611 by employing the table 6101c shown in FIG. 4C. Then, the security level determining unit 607 determines a summation value of the evaluation values of the respective records 6110 of the area information management TBL storage unit 611, which have been calculated in the above-described manner, as a security level of this area. The determined security level is transmitted to the authentication control unit 609 by this security level determining unit 607. It should be understood that a security level indicates such a fact that the higher the security level becomes, the higher the security is required by the structural elements 70.

A trust level determining unit 608 determines a trust level of this room entering person by employing both the information stored in the trust level management TBL storage unit 612 and the attribute information of the user received from the room-entering-person information acquiring unit 606. Then, the trust level determining unit 608 transmits the determined trust level to the authentication control unit 609.

FIG. 5A to FIG. 5C illustratively indicate an example of contents registered in the trust level management TBL storage unit 612. FIG. 5A indicates a table 6121a which is used so as to determine an evaluation value related to attributes (status, belonging section) of a room entering person. FIG. 5B indicates a table 6121b which is used so as to determine an evaluation value related to a use frequency of the internal network system of the building by a room entering person. FIG. 5C indicates a table 6121c which is used to determine an evaluation value related to a place where a room entering person accesses the room area 10. An evaluation value 6123 has been registered in each of these tables 6121a to 6121c every attribute (status, belonging section) of the room entering person, the actual use result thereof, and the access place 6122 thereof.

The trust level determining unit 608 specifies such an evaluation value corresponding to the user attribute received from the room-entering-person information acquiring unit 606 by employing the table 6121a shown in FIG. 5A. Similarly, the trust level determining unit 608 specifies such an evaluation value corresponding to the use frequency received from the room-entering-person information acquiring unit 606 by employing the table 6121b shown in FIG. 5B. Also, the trust level determining unit 608 specifies such an evaluation value corresponding to the access place received from the room-entering-person information acquiring unit 606 by employing the table 6121c shown in FIG. 5C. Then, the trust level determining unit 608 determines a summation value of the evaluation values of the respective attribute information which has been calculated in the above-described manner, as a trust level. The determined trust level is transmitted to the authentication control unit 609 by this trust level determining unit 608. It should be understood that a trust level indicates such a fact that the higher the trust level becomes, the higher the reliability of the room entering person becomes.

The authentication control unit 609 performs a process operation for issuing an authentication ticket and another process operation for issuing an access ticket. The authentication ticket certificates such a room entering person who is authenticated to the room area 10. The access ticket certificates an access right with respect to an electronic appliance corresponding to the structural element 70. Both the process operations for issuing the authentication ticket and the process operation for issuing the access ticket will be described later.

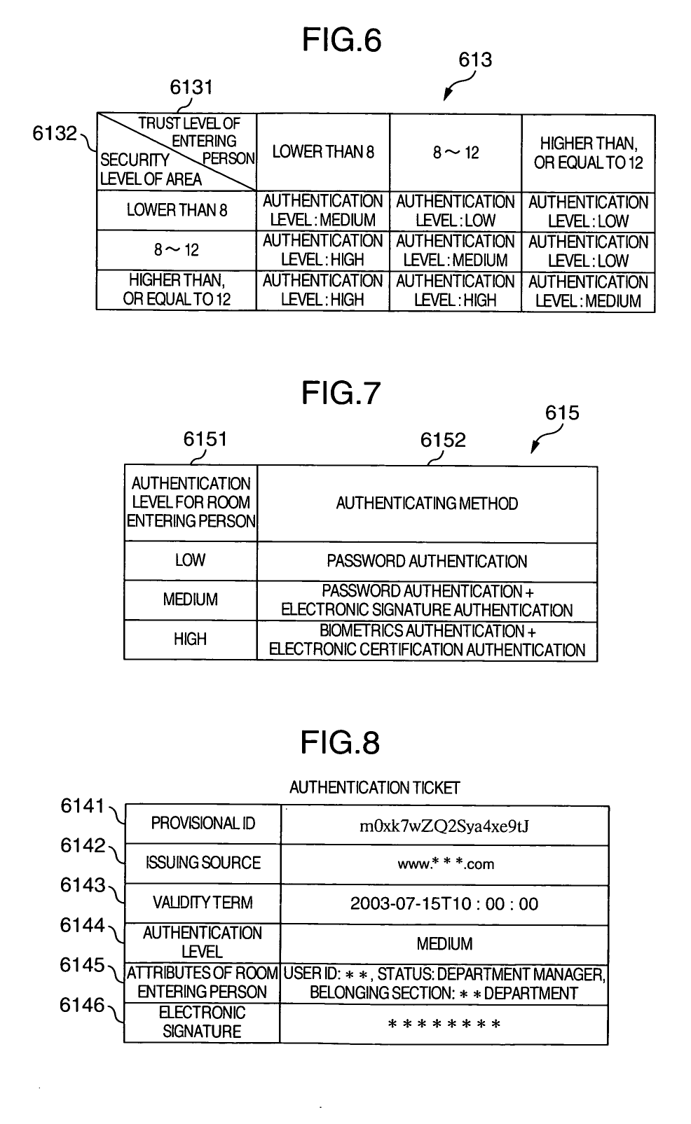

As indicated in FIG. 6, authentication levels used to authenticate room entering persons have been registered in the authentication level management TBL storage unit 613 every combination between a trust level 6131 and a security level 6132. The authentication levels imply that the higher the authentication level becomes, the severer the security check is required.

As indicated in FIG. 7, authenticating methods used to authenticate room entering persons have been registered in the authenticating method management storage unit 615 every authentication level. In the example shown in FIG. 7, in such a case that an authentication level is “low”, an authenticating method by way of a password of a room entering person is employed; in such a case that an authentication level is “medium”, an authenticating method by way of both a password of a room entering person and an electronic signature is employed; and then, in such a case that an authentication level is “high”, an authenticating method by way of biological information and an electronic signature is employed.

Both the authentication ticket and the access ticket, which have been issued by the authentication control unit 609, are registered in the ticket management TBL storage unit 614.

FIG. 8 is an explanatory diagram for explaining one example of an authentication ticket which allows a temporal room entering operation by a room entering person who enters a relevant area. In this example, the authentication ticket is formed as an XML type of electronic data. As represented in this drawing, the authentication ticket owns a provisional ID 6141, identification information (for example, IP address) 6142 of the authentication control apparatus 60 of the thicket issuing source, a validity term 6143 of the authentication ticket, an authentication level 6144, room entering person attributes 6145, and also, an electronic signature 6146. The provisional ID 6141 corresponds to unique information which is used to identify the authentication ticket. This provisional ID 6141 is registered as identification information into a field 6111 of the record 6110c of the room entering person of this authentication ticket which is added to the area information management TBL storage unit 611. In order to guarantee a unique characteristic, the provisional ID 6141 may be alternatively produced by coupling, for example, the identification information of the authentication control apparatus 60 of the ticket issuing source to such a serial number responding to a total producing number of the authentication ticket in this authentication control apparatus 60. The validity term 6143 of the authentication ticket may be alternatively defined as, for instance, a day after a predetermined time period has elapsed from today. As the room entering person attributes 6145, such attribute information (user ID), status, belonging section) of the room entering person, which has been acquired by the room-entering-person information acquiring unit 606. Then, the electronic signature 6145 may be alternatively produced by employing a signature key of the authentication control apparatus 60 of the issuing source with respect to a message digest as to, for example, the provisional ID 6141, the identification information 6142 of the authentication control apparatus 60 of the ticket issuing source, the validity term 6143 of the authentication ticket, the authentication level 614, and the room entering person attribute 6145.

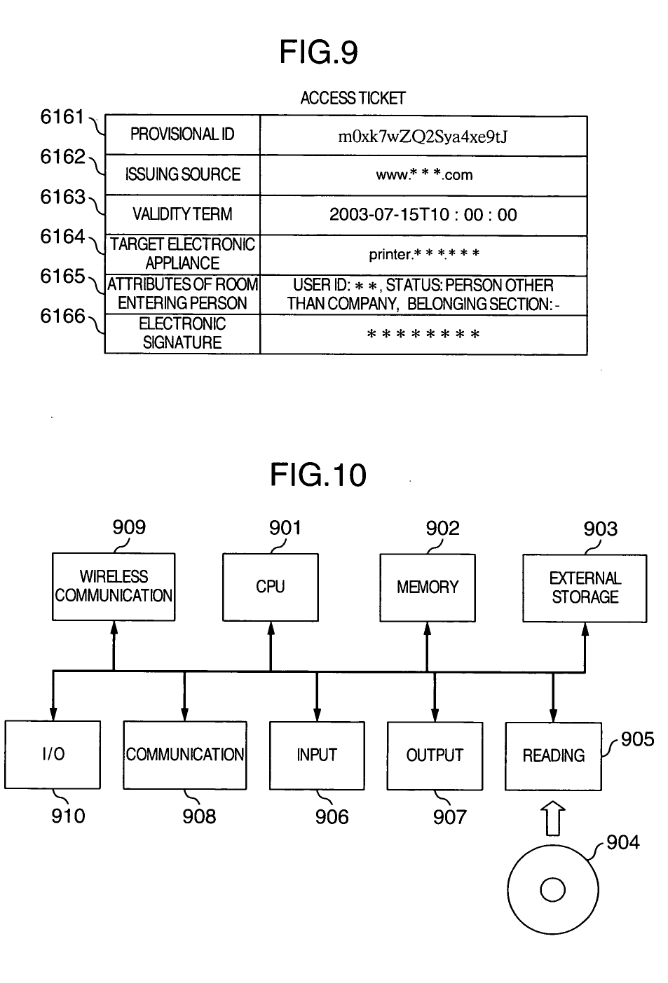

FIG. 9 is an explanatory diagram for explaining an example of an access ticket for allowing a room entering person to access an electronic appliance provided in a room area. Similar to the authentication ticket indicated in FIG. 8, also in this example, the access ticket is formed as an XML type of electronic data. As represented in this drawing, the access ticket contains a provisional ID 6161, identification information (for example, IP address) 6162 of the authentication control apparatus 60 of the ticket issuing source, a validity term 6163 of the access ticket, identification information 6164 of an access target electronic appliance, a room entering person attribute 6165, and an electronic signature 6166. In the access ticket, the contents other than the identification information 6164 may be made similar to those of the authentication ticket.

The authentication control apparatus 60 having the above-described construction may be realized as follows: That is, for example, as indicated in FIG. 10, in such a computer system equipped with a CPU 901, a memory 902, an external storage apparatus 903 such as an HDD (hard disk drive), a reading apparatus 905, an input apparatus 906 such as a keyboard and a mouse, an output apparatus 907 such as a display, a communication apparatus 908, a wireless communication apparatus 909, and an I/O apparatus 910, since the CPU 901 executes a predetermined program loaded on the memory 902, the authentication apparatus 60 may be realized. The reading apparatus 905 reads out information from a storage medium 904 having a portability characteristic such as a CD-ROM and a DVD-ROM. The communication apparatus 908 is communicated to an apparatus of a counter party via a network. The wireless communication apparatus 909 is communicated to the user terminal 80 and the HT 90 in a wireless manner. The I/O apparatus 910 is employed so as to output a control signal with respect to an open/close mechanism such as a door and a gate. This predetermined program may be alternatively downloaded from the storage medium 904 via the reading apparatus 905 to the external storage apparatus 903. Otherwise, the predetermined program may be alternatively downloaded form the network via the communication apparatus 908 to the external storage apparatus 903. Thereafter, this downloaded program may be alternatively loaded onto the memory 902 so as to be executed by the CPU 901. Alternatively, the above-described program may be loaded from the storage medium 904 via the reading apparatus 905, otherwise, may be directly loaded from the network via the communication apparatus 908 onto the memory 902 so as to be executed by the CPU 901. In this case, as the storage units 610 to 615, the memory 902, the external storage apparatus 903, and the storage medium 904 may be utilized.

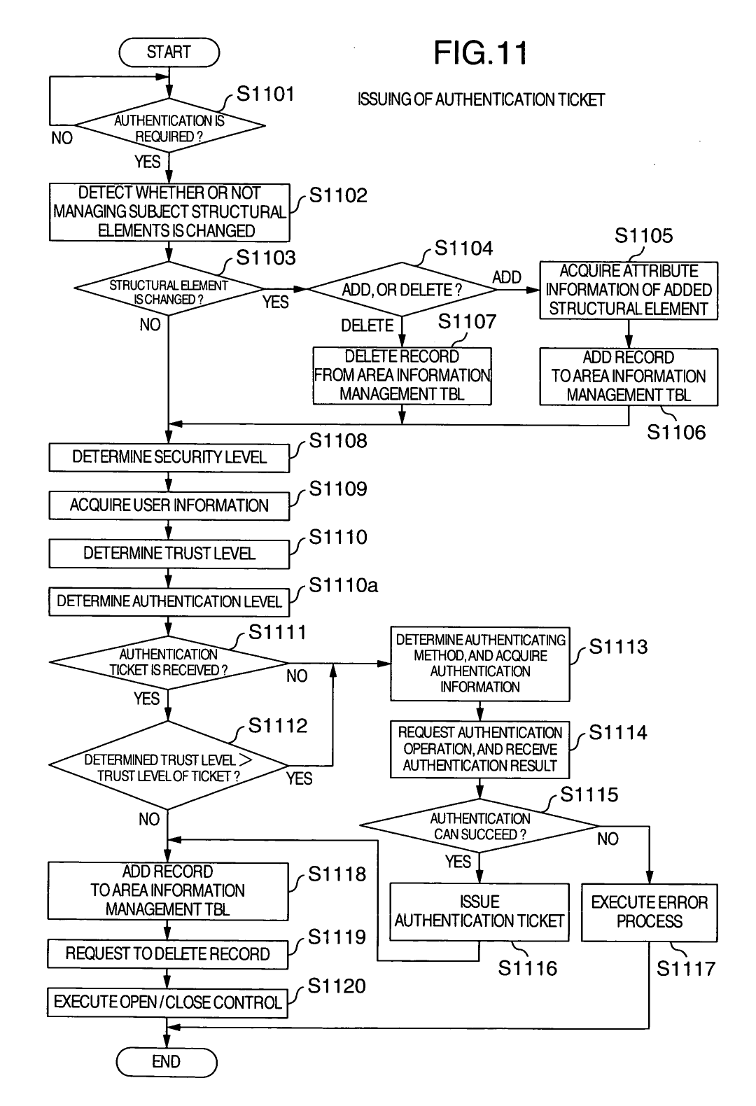

FIG. 11 is a flowchart for explaining process operation for issuing an authentication ticket with respect to a room entering person by the authentication control apparatus 60 when the room entering person requests authentication at the entrance of the room area 101.

When the authentication control unit 609 accepts an authentication request form the room entering person via the instruction accepting unit 603 (Step S1101), the authentication control unit 609 requests the area information acquiring unit 605 to detect whether or not the present structural elements 70 belonging to the relevant room area 10 are different from such structural elements that have already been registered. Upon receipt of this request, the area information acquiring unit 605 sequentially transmits PING (Packet Internet Groper) with respect to, for instance, an IP address having a sub-network of the relevant room area 10, and detects an IP address of the present electronic appliance belonging to the relevant room area 10 by confirming responses thereof. Then, the authentication control unit 609 compares the detected IP address of each of the electronic appliances with the identification information (IP address) of the electronics appliance within the same room area that has been registered in the field 6111 of the record 6110b registered in the area information management TBL storage unit 611. As a result of this comparing operation, the authentication control unit 609 detects whether or not the structural elements 70 are changed (Step S1102).

In a case where “no change” is detected in the step S1102, in other words, in such a case that the IP address of each of the structural electronic appliances detected in the relevant room area is made coincident with the identification information of each of the structural electronic appliances registered in the area information management TBL storage unit 611 (“NO” in Step S1103), the process operation is advanced to Step S1108. On the other hand, in a case where “change” is detected in Step S1102 (“YES” in Step S1103), the area information acquiring unit 605 further checks whether or not a structural electronic appliance is added to the structural elements 70, or deleted from the structural elements 70 (Step S1104).

When the area information acquiring unit 605 judges that in Step S1104 the structural electronic appliance is deleted, namely, in a case where such an IP address that is not present in the IP addresses of the respective structural electronic appliances detected at the current time has been registered in the area information management TBL storage unit 611 as the identification information of the structural electronic appliance, the area information acquiring unit 605 deletes the record 6110b from the area information management TBL storage unit 611, in which this identification information has been registered in the field 6111 (Step S1107). Thereafter, the process operation is advanced to Step S1108. On the other hand, when the area information acquiring unit 605 judges in Step S1104 that the structural electronic appliance is added, namely, in a case where such an IP address which is not registered in the area information management TBL storage unit 611 as the identification information of the structural electronic appliance is present in the IP addresses of the respective structural appliances detected at the current time, the area information acquiring unit 605 acquires attribute information (which contains above-explained information of sort (large) and information of sort (small)) from the electronic appliance of the relevant IP address by employing, for example, SNMP (Simple Network Management Protocol) in Step S1105. Then, the area information acquiring unit 605 adds the record 6110b of the electronic appliance to the area information management TBL storage unit 611, registers this IP address to the field 6111 of this record 6110b, and also, registers the acquired attribute information to the field 6112 (Step S1106). As a consequence, the structural element within the related room area is made coincident with the structural element at this time. Thereafter, the process operation is advanced to Step S1108.

Next, in Step S1108, the area information acquiring unit 605 reads out all of the records 6110 which have been registered in the area information management TBL storage unit 611, and then, transmits all of the read records 6110 to a security level examining unit 607 so as to request a decision of a security level. Upon receipt this request, the security level determining unit 610 determines a security level of the relevant area at the present time by employing both the respective records 6110 of the area information management TBL storage unit 611 accepted from the area information storage unit 605, and also, the security level management TBL storage unit 610. Then, the security level determining unit 610 transmits the determined security level to the authentication control unit 609.

Next, the authentication control unit 609 requests the room-entering-person information acquiring unit 606 to acquire attribute information of a room entering person. Upon receipt of this request, the room-entering-person information acquiring unit 606 is communicated to the HT 90 via the wireless communication unit 602 so as to acquire the attribute information (user ID, status, belonging section, use frequency etc.) of the room entering person from this HT 90. Alternatively, the room-entering-person information acquiring unit 606 is communicated to the user terminal 80 via the wireless communication unit 602 in order to the attribute information of the room entering person from the HT 90 via the user terminal 80 (Step S1109). In this case, if an authentication ticket has already been registered in the HT 90, then the room-entering-person information acquiring unit 606 also acquires this authentication ticket in combination with the attribute information of the room entering person from the HT 90.

Next, the room-entering-person information acquiring unit 606 transmits the attribute information of the room entering person acquired from the HT 90 to the trust level examining unit 608 so as to request a decision of a trust level. In this case, if the authentication ticket has been obtained from the HT 90, then the room-entering-person information acquiring unit 606 transmits this authentication ticket to the trust level determining unit 608 in combination with the above-explained attribute information. Upon receipt of this request, the trust level determining unit 608 determines a trust level of the room entering person by employing both the attribute information of the room entering person accepted from the room-entering-person information acquiring unit 606, and also, the trust level management TBL storage unit 612 (step S1110). Then, the trust level determining unit 608 transmits the determined trust level to the authentication control unit 609. At this time, if the trust level determining unit 608 has accepted the authentication ticket which had already been acquired by the room entering person from the room-entering-person information acquiring unit 606, then this trust level determining unit 608 also transmits this authentication ticket to the authentication control unit 609 in combination with the above-explained attribute information. In this embodiment, as the information of the access place (see FIG. 5C) which is employed so as to determine the trust level, the information has been previously set to the trust level determining unit 608 in such a manner that “entrance” becomes the access place in the authentication control apparatus 60, installed in the room area 10, (on the floor 1F), and “place within company” becomes the access place in the authentication control apparatus 602 installed on the floor 2F, or higher floors.

Next, when the authentication control unit 609 accepts both the security level from the security level determining unit 607 and the trust level from the trust level determining unit 608, the authentication retrieves an authentication level of the room entering person authenticating operation, which corresponds to the combination of the accepted security level and the accepted trust level, from the authentication level management TBL storage unit 613 (see FIG. 6), and then, determines the retrieved authentication level as an authentication level which is utilized so as to authenticate the room entering person (Step S1110a).

Next, in such a case that the authentication control unit 609 does not accept the authentication ticket (namely, authentication ticket registered in HT 90) from the trust level determining unit 908 (“NO” in Step S1111), the process operation is advanced to Step S1113. When the authentication control unit 609 accepts the authentication ticket from the trust level determining unit 908 (“YES” in Step S1111), the authentication control unit 609 compares the authentication level 6144 (see FIG. 8) described in this authentication ticket with the authentication level determined in the step S1110a, and cheeks whether or not the latter authentication level is higher than the former authentication level (step S1112). In the case that the determined authentication level of the authentication ticket is higher than the authentication level registered in the HT 90 (“YES” in Step S1112), the authentication control unit 609 recognizes that the room entering person must be again authenticated, and thus, the process operation is advanced to Step S1113. On the other hand, in the case that the determined authentication level of the authentication ticket is lower than the authentication level registered in the HT 90 (“NO” in Step S1112), the authentication control unit 609 recognizes that the room entering person need not be again authenticated, and thus, the process operation is advanced to Step S1118.

In Step S1113, the authentication control unit 609 retrieves such an authenticating method corresponding to the authentication level determined in the step S1110a from the authenticating method management TBL storage unit 615, and then, determines the retrieved authenticating method as such an authenticating method which is employed so as to authenticate the room entering person. Then, the authentication control unit 609 acquires from the room entering person, such an authentication information which is required to execute an authenticating operation by the determined authenticating method (Step S1113). Concretely speaking, in the case that the authenticating method is “password authentication”, for instance, a message for prompting an input of the password is displayed, and since the authentication control unit 609 accepts the input of the password via the instruction accepting unit 603 from the room entering person, the authentication information is acquired. Also, in the case that the authenticating method is “password authentication+electronic signature authentication”, the authentication control unit 609 accepts an input of a password from a room entering person in the above-described manner, and also, transmits signature subject data (for example, random number) via the wireless communication unit 602 to the HT 90. Then, since the authentication control unit 609 accepts an electronic signature with respect to this signature subject data, the authentication information is acquired. Also, in the case that the authenticating method is “biological authentication+electronic signature authentication), the authentication control unit 609 accepts an electronic signature with respect to the transmission data in the above-explained manner, and also, for instance, while such a message that biological information is acquired is displayed, the authentication control unit 609 acquires the biological information by employing a biological information acquiring apparatus (for example, fingerprint acquiring apparatus and pupil acquiring apparatus) which is not shown in the drawing, so that the authentication information is acquired.

Next, the authentication control unit 609 produces an authentication request, and then transmits this produced authentication request via the network IF unit 601 to the authentication apparatus 50. The authentication request contains the user ID included in the attribute information of the room entering person acquired in Step S1109, and the designation of the authenticating method, and also, the acquired authentication information. Upon receipt of this authentication request, the authentication apparatus 50 authenticates the authentication information by employing the designated authenticating method. Then, the authentication apparatus 50 transmits this authentication result to the authentication control apparatus 609 functioning as the authentication request source (Step S1114). In this case, as an interface used to be cooperated to the authentication apparatus 50, for example, LDAP (Lightweight Directory Access Protocol) which corresponds to the standard protocol of the directory, and Radius (Remote Authentication Dial-In User Service) which corresponds to the standard protocol of the remote user authentication may be utilized. A detailed content of this authentication apparatus 50 will be explained later.

Next, in the case that the authentication result received from the authentication apparatus 50 indicates a failure of the authentication operation (“NO” in Step S1115), the authentication control unit 609 executes an error processing operation in such a manner that, for example, an error message is displayed on a display apparatus (not shown) (Step S1117), and thereafter, the authentication control unit 609 accomplishes this flow operation. On the other hand, in such a case that the authentication result received from the authentication apparatus 50 indicates a success of the authentication operation (“YES” in Step S1115), the authentication control unit 609 produces an authentication ticket (see FIG. 8), and then, stores this produced authentication ticket into the ticket management TBL storage unit 614. Alternatively, the authentication control unit 609 stores this produced authentication ticket via the user terminal 80 to the HT 90 (Step S1116). Thereafter, the process operation is advanced to Step S1118.

In Step S1118, the authentication control unit 609 notifies either the authentication ticket which has been judged in the previous Step S1112 that this authentication ticket need not be again authenticated, or both the provisional ID and the user attribute of the authentication ticket which has been newly issued in Step S1116 to the area information acquiring unit 605, and requests the area information management TBL storage unit 611 to add a record. Upon receipt of this request, the area information acquiring unit 605 adds the record 6110c of the room entering person to the area information management TBL storage unit 611 as a room existing person (structural element) in this area, and registers the provisional ID notified from the authentication control unit 609 into the field 6111 of this record 6110c, and also, registers the user attribute notified from the authentication control unit 609 into the field 6112.

Next, the authentication control unit 609 produces a record deletion request, and then transmits this record deletion request via the network IF unit 601 to another authentication control apparatus 60 (Step S1119). This record deletion request is combined with the designation made by the authentication ticket which has been judged in Step S1112 by that this authentication ticket need not be again authenticated, or the provisional ID of the authentication ticket which has been newly issued in Step S1116. This record deletion request is used to delete that this room entering person becomes the room existing person (structural element) in another area. Upon receipt of this record deletion request, the area acquiring unit 605 of another authentication control apparatus 60 retrieves the record 6110c of the user for the area information management TBL storage unit 611, and then, deletes the retrieved record 6110c. In the record 6110c of the user, the provisional ID designated by the record deletion request has been recorded as the identification information in the field 6111.

Subsequently, the authentication control unit 609 causes the open/close control unit 604 to open and/or close the door, or the gate in order that the room entering person can enter such a floor that the sub-segment 10 of the own authentication control apparatus 60 (Step S1120). Thereafter, the authentication control unit 609 accomplishes this flow operation.

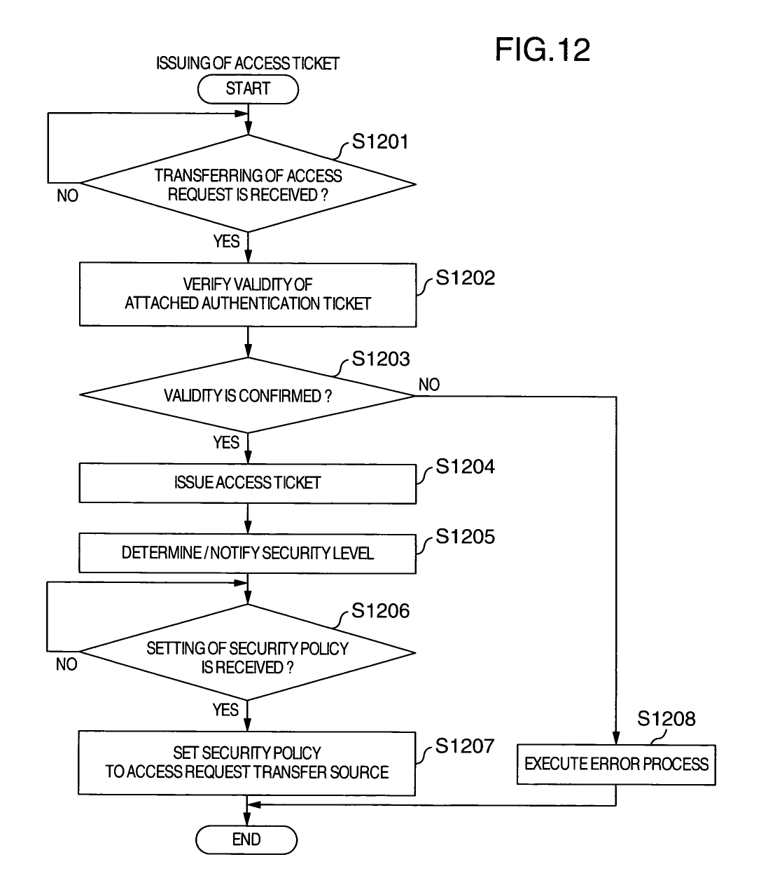

FIG. 12 is a flowchart for explaining a process operation for issuing an access ticket of the authentication control apparatus 60.

When a room existing person within the room area 10 issues an access request to an electronic appliance employed in the room area 10, this access request is transferred from this accessed electronic appliance via the network IF unit 601 to the authentication control unit 609 related to this room area 10. When this access request is transferred to the authentication control unit 609 (Step S1201), the authentication control unit 609 verifies validity of an authentication ticket which is attached to this access request (Step 1202). In the case that the present date does not exceed a validity term 6143 of the authentication ticket, and further, a signature verifying operation of an electronic signature 6146 of the authentication ticket can succeed, the authentication control apparatus 60 judges that the authentication ticket is justified. It should also be assumed that since the authentication control apparatus 60 owns signature verifying keys of authentication control apparatus 60, the authentication control apparatus 60 verifies the signature of the electronic signature 6146 of the authentication ticket by employing the signature verifying key which corresponds to the authentication control apparatus 60 of the authentication ticket issuing source 6142.

Then, in the case that the justification of the authentication ticket is not confirmed (“NO” in Step S1203), the authentication control unit 609 executes an error processing operation in such a manner that a message of this no justification is transmitted via the network IF unit 601 to the structural electronic appliance of the transfer source of the access request (Step S1208), and then, this flow operation is ended.

On the other hand, in the case that the justification of the authentication is confirmed (“YES” in Step S1203), the authentication control unit 609 produces an access ticket (see FIG. 9), and stores this produced access ticket to the ticket management TBL storage unit 614. Also, the authentication control unit 609 transmits this produced access ticket via the network IF unit 601 to the structural electronic appliance of the transfer source of the access request (Step S1204).

Next, the authentication control unit 609 requests the security level determining unit 607 so as to determine a security level. Upon receipt of this request, the security level determining unit 607 reads out all of the records 6110 which have been registered in the area information management TBL storage unit 611 via the area information acquiring unit 605. Then, the security level determining unit 607 determines a security level by using each of the read records 6110 and the security level management TBL storage unit 610, and then, transmits the determined security level to the authentication control unit 609. The authentication control unit 609 transmits this security level via the network IF unit 601 to the structural electric appliance of the transfer source of the access request (Step S1205).

Next, when the authentication control apparatus 609 receives a security policy which is set to the relevant structural electronic appliance via this structural electronic appliance of the transfer source of the access request (Step S1206), the authentication control apparatus 609 applies the provisional ID of the access ticket issued in Step S1203 to this security policy, and then, resends this security policy attached with the provisional ID of the access ticket to the structural electronic appliance of the transfer source of the access request (Step S1207). Thereafter, this flow operation is ended. Upon receipt of this resent security policy, the structural electronic appliance of the transfer source of the access request applies the security policy corresponding to the provisional ID 6161 of this access ticket with respective of the access request combined with the access ticket. Thereafter, this flow operation is ended.

Returning back to FIG. 1, the description is continued. The authentication apparatus 50 executes an authenticating operation of a room entering person in response to an authentication request received from the authentication control apparatus 60, and then, notifies the authentication result to the authentication control apparatus 60.

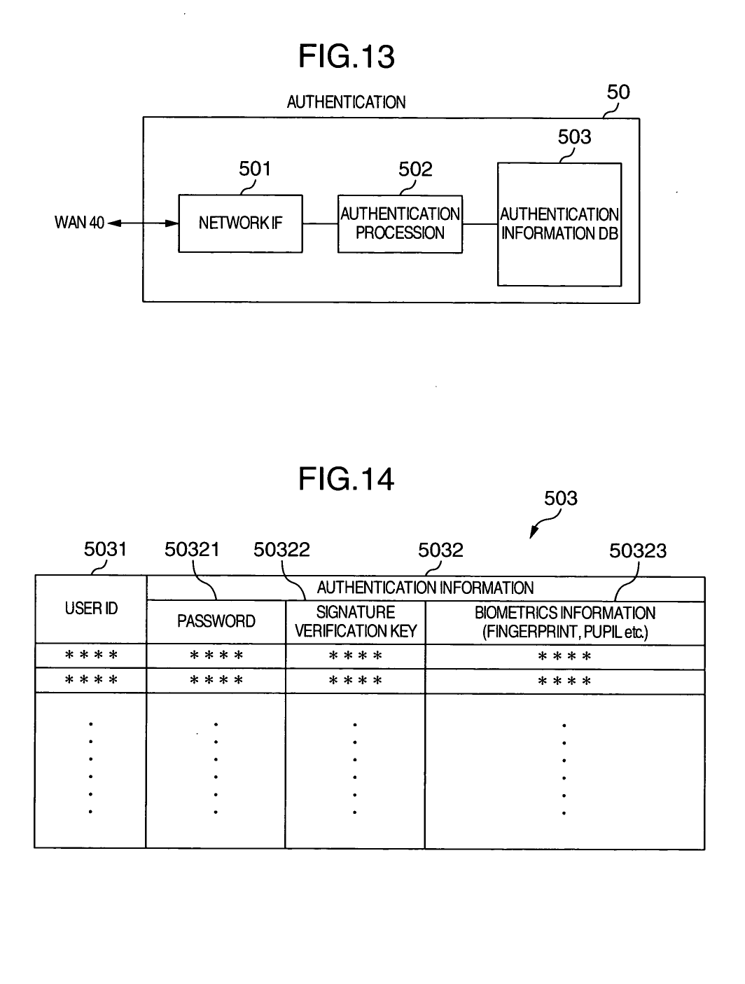

FIG. 13 is a schematic diagram for showing an internal arrangement of the authentication apparatus 50. As indicated in this drawing, the authentication apparatus 50 contains a network IF unit 501, an authentication processing unit 502, and an authentication information DB (database) 503 into which authentication information has been registered every room entering person of the internal network system of the building. The network IF unit 501 is communicated to each of the authentication control apparatus 60 of the internal network system of the building via a WAN 40. The authentication processing unit 502 authenticates authentication information of an authentication request subject by employing the authentication information DB 503 based upon the authenticating method which is designated by the authentication request received via the network IF unit 501 by the authentication control apparatus 60. Then, the authentication apparatus 50 transmits the authentication result to the authentication control apparatus 60 of the authentication request source.

FIG. 14 is a diagram for indicating an example of registered contents of the authentication information DB 503. In this database 503, both a field 5031 into which user IDs of room entering persons have been registered, and another field 5032 into which authentication information of these room entering persons have been registered are provided so as to constitute a single record. The field 5032 contains a sub-field 50321, another sub-field 50322, and another sub-field 50323. In this sub-field 50321, passwords of these room entering persons have been registered. In the sub-field 50322, signature verifying keys (keys which constitute pairs of signature keys of room entering persons which have been registered in HT 90) of the room entering persons have been registered. In the sub-field 50323, biometics information (fingerprint, pupil etc.) of the room entering persons have been registered.

The authentication apparatus 50 having the above-described arrangements may be realized by that in such a computer system having a general-purpose arrangement (namely, for example, both wireless communication apparatus 909 and I/O apparatus 910 are omitted from arrangement shown in FIG. 10), the CPU 901 executes a predetermined program loaded on the memory 902. In this case, the memory 902, the external storage apparatus 903, and the storage unit 904 are utilized in the authentication information DB 503.

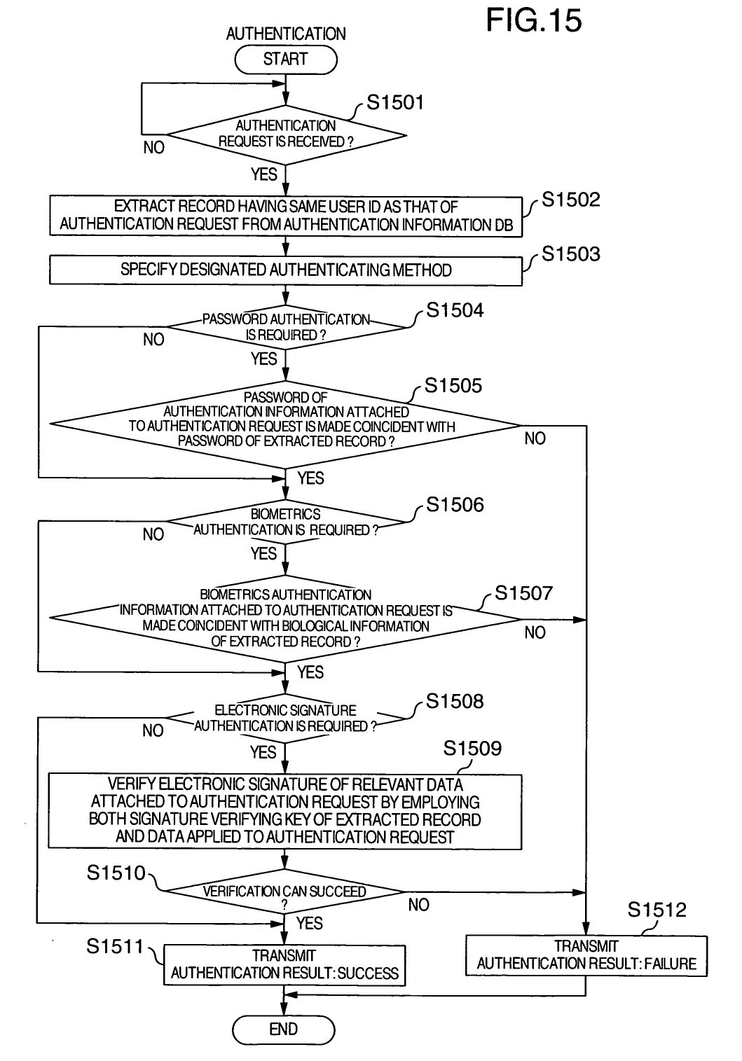

FIG. 15 is a flowchart for explaining an authenticating process operation of the authentication apparatus 50.

When the authentication processing unit 502 receives an authentication request via the network IF unit 501 from the authentication control apparatus 60 (Step S1501), the authentication processing unit 502 extracts such a record that a user ID contained in this authentication request is registered in the field 5031 from the authentication information DB 503 (Step S1502). Thereafter, the authentication processing unit 502 specifies an authenticating method which is designated by this authentication request (Step S1503). In this embodiment, as explained above, it is so assumed that at least one of the password authentication, the biological information authentication, and the electronic signature authentication is designated.

Next, the authentication processing unit 502 checks whether or not the designated authenticating method contains the password authentication (Step S1504). When the designated authenticating method does not contain the password authentication, the process operation is advanced to Step S1506. When the designated authenticating method contains the password authentication, the authentication processing unit 502 checks whether or not the password contained in the authentication request is made coincident with such a password which has been registered in the sub-field 50321 of the record extracted in Step S1502 (Step S1505). Then, when these passwords are made coincident with each other, the process operation is advanced to Step S1506. When these passwords are not made coincident with each other, the authentication processing unit 502 judges that the authentication cannot be established, and transmits an authentication result indicative of this fact to the authentication control unit 60 of the authentication request source (Step S1512).

Next, the authentication processing unit 502 checks whether or not the designated authenticating method contains the biological information authentication in Step S1506. When the designated authenticating method does not contain the biological information authentication, the process operation is advanced to Step S1508. When the designated authenticating method contains the biological information authentication, the authentication processing unit 502 checks whether or not the biological information contained in the authentication request is made coincident with such a biological information which has been registered in the sub-field 50323 of the record extracted in Step S1502 (Step S1507). Then, when the sets of the biological information are made coincident with each other, the process operation is advanced to Step S1508. When the sets of the biological information are not made coincident with each other, the authentication processing unit 502 judges that the authentication cannot be established, and transmits an authentication result indicative of this fact to the authentication control unit 60 of the authentication request source (Step S1512).

Next, the authentication processing unit 502 checks whether or not the designated authenticating method contains the electronic signature authentication (Step S1508). When the designated authenticating method does not contain the electronic signature authentication, the process operation is advanced to Step S1511. When the designated authenticating method contains the electronic signature authentication, the authentication processing unit 502 decodes the electronic signature contained in the authentication request based upon the signature verifying key which has been registered in the sub-field 50322 of the record extracted in Step S1502. Then, the authentication processing unit 502 checks as to whether or not the decoded result is made coincident with signature subject data contained in the authentication request (Step S1509). When the decoded electronic signature is made coincident with the signature subject data, the process operation is advanced to Step S1511. When these signatures are not made coincident with each other, the authentication processing unit 502 judges that the authentication cannot be established, and transmits an authentication result indicative of this fact to the authentication control unit 60 of the authentication request source (Step S1512).

Next, in Step S1511, the authentication processing unit 502 judges that the authentication can be established, and transmits an authentication result indicative of this fact to the authentication control unit 60 of the authentication request source.

Returning back to FIG. 1, the description is continued. The HT 90 stores thereinto various sorts of information such as attribute information (user ID, status, belonging section, use frequency) of a room entering person, an authentication information (password), an authentication ticket, and an access ticket, and also, produces an electronic signature.

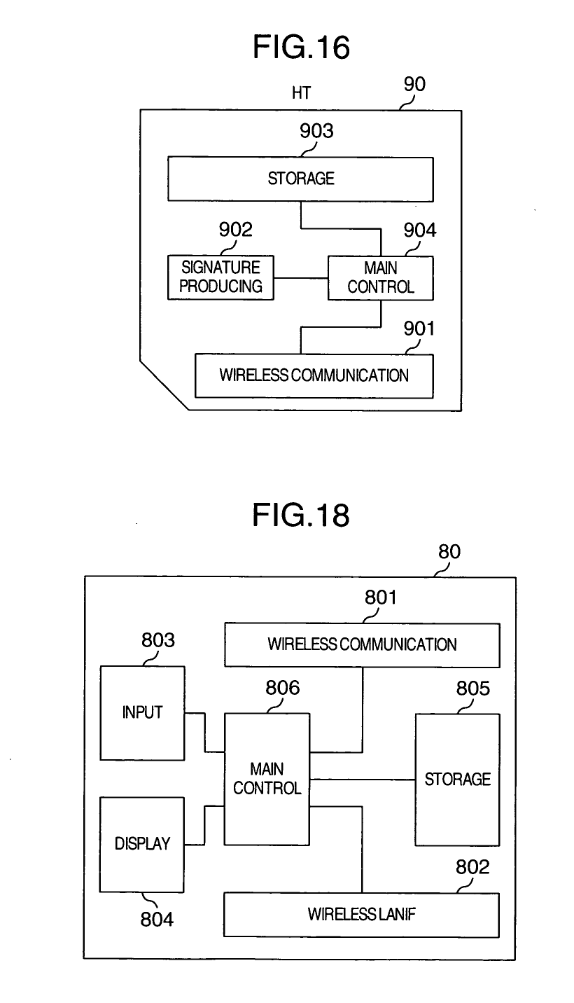

FIG. 16 is a schematic diagram for indicating an internal arrangement of the HT 90. As indicated in this drawing, the HT 90 contains a wireless communication IF unit 901, a signature producing unit 902, a storage unit 903, and a main control unit 904. The wireless communication IF unit 901 is communicated to both the user terminal 80 and the authentication control apparatus 60 by way of a short distance wireless communication such as an infrared communication. Otherwise, the HT 90 is mounted on the user terminal 80. The attribute information (user ID, status, belonging section, use frequency) of the room entering person, the authentication information (password), and a signature key have been previously registered in the storage unit 903. It should be noted that the user frequency among the attribute information of the room entering person corresponds to such an information to be updated. Also, the authentication ticket and the access ticket are registered into the storage unit 903. The signature producing unit 902 produces an electronic signature with respect to such a data which is received via the wireless communication unit 901 via the user terminal 80 by employing the signature key stored in the storage unit 903. Then, the main control unit 904 controls the above-explained respective units 901 to 903 in a unified manner. This HT 90 may be realized in such a manner that in the normal hardware token equipped with a CPU, a memory having a tamper resist structure, and an I/O device for executing a short distance wireless communication such as an infrared communication, the CPU executes a predetermined program stored in the memory. In this case, the memory is utilized in the storage unit 903.

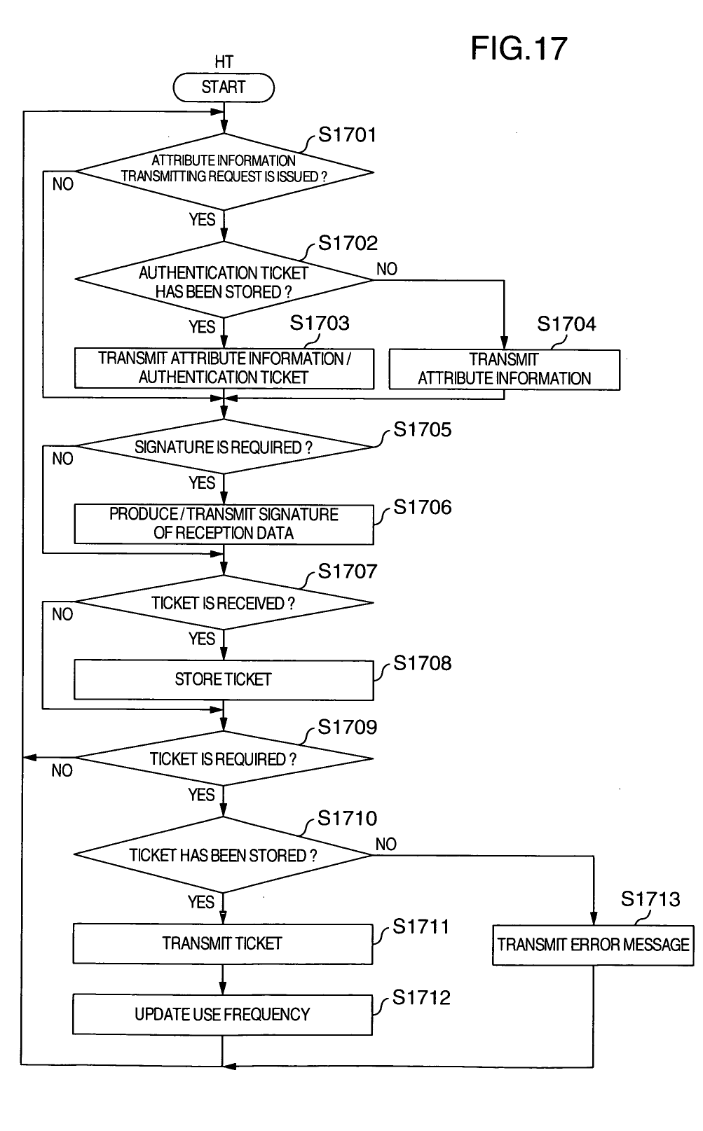

FIG. 17 is a flowchart for explaining operations of the HT 90. When the HT 90 is approached to either the user terminal 80 or the authentication control apparatus 60, this HT 90 establishes a communication path between a communication apparatus of a counter party and the HT 90 by way of the short distance wireless communication such as the infrared communication. Then, when the communication path is established, this flow operation is commenced. It should also be understood that as to the communication path with respect to the communication apparatus of the counter party, security has been secured by mutually authenticating the own HT 90 and the communication apparatus of the counter party.

First of all, when the main control unit 904 receives an attribute information transmission request from the communication apparatus of the counter party via the wireless communication unit 901 (Step S1701), the main control unit 904 checks whether or not an authentication ticket has already been stored in the storage unit 903 (Step S1702). In the case that the authentication ticket has been stored in the storage unit 903, the main control unit 904 reads both the attribute information of the room entering person and the authentication ticket from the storage unit 903, and then transmits the read attribute information and the read authentication ticket to the communication apparatus of the counter party (Step S1703). On the other hand, in the case that the authentication ticket has not yet been stored in the storage unit 903, the main control unit 904 reads the attribute information of the room entering person from the storage unit 903, and then transmits the read attribute information to the communication apparatus of the counter party (Step S1704).

Also, when the main control unit 904 receives a signature request from the communication apparatus of the counter party via the wireless communication unit 901 (Step S1705), this main control unit 904 transfers signature request data (for instance, random number) which is contained in this signature request to the signature producing unit 902. Upon receipt of this signature subject data, the signature producing unit 902 produces an electronic signature with respect to the signature subject data by employing the signature key stored in the storage unit 903. The main control unit 904 transmits this produced electronic signature to the communication apparatus of the counter party (Step S1706).

Also, when the main control unit 904 receives either an authentication ticket or an access ticket from the communication apparatus via the wireless communication unit 901 (Step S1707), the main control unit 904 stores this received ticket into the storage unit 903 (Step S1708).

Also, when the main control unit 904 receives a transmission request of either an authentication ticket or an access ticket from the communication apparatus of the counter party via the wireless communication unit 901 (Step S1709), the main control unit 904 checks whether or not the relevant ticket has been stored in the storage unit 903 (Step S1710). The access ticket designates identification information 6164 of an access subject appliance. In the case that the relevant ticket has been stored in the storage unit 903, the main control unit 904 reads out the relevant ticket from the storage unit 903, and then, transmits this read ticket to the communication apparatus of the counter party (Step S1711). Thereafter, the main control unit 904 updates the use frequency of the attribute information of the user which has been stored in the storage unit 903 (Step S1712). On the other hand, when the relevant ticket has not yet been stored, the main control unit 904 transmits an error message to the communication apparatus of the counter party (Step S1713).

Returning back to FIG. 1, the description is continued. The user terminal 80 controls both a writing operation and a reading operation as to the various sorts of information for the HT 90. Also, the user terminal 80 requests the HT 90 to produce an electronic signature.

FIG. 18 is a schematic diagram for showing an internal arrangement of the user terminal 80. As shown in this drawing, the user terminal 80 contains a wireless communication unit 801, a wireless LANIF unit 802, an input unit 803, a display unit 804, a storage unit 805, and a main control unit 806. The wireless communication unit 801 is communicated to both the HT 90 and the authentication control apparatus 60 by way of a short distance wireless communication such as an infrared communication. The wireless LANIF unit 802 corresponds to an interface used to be communicated to the wireless AP 701. The input unit 803 accepts an instruction issued from a room entering person and an input of information. The display unit 804 displays thereon the information. The storage unit 805 stores thereinto various sorts of information, if required. Then, the main control unit 806 controls the respective units 801 to 803 in a unified manner. The user terminal 80 may be realized by such a manner that in an information terminal such as a PDA (Personal Digital Assistant), a CPU executes a predetermined program stored in a memory. This information terminal is equipped with the CPU, the memory, an input apparatus such as an operation button and a touch panel, a display apparatus such as a liquid crystal panel, an I/O apparatus used to perform a short distance wireless communication such as an infrared communication, and a wireless LAN communication apparatus. In this case, the memory is utilized in the storage unit 805.

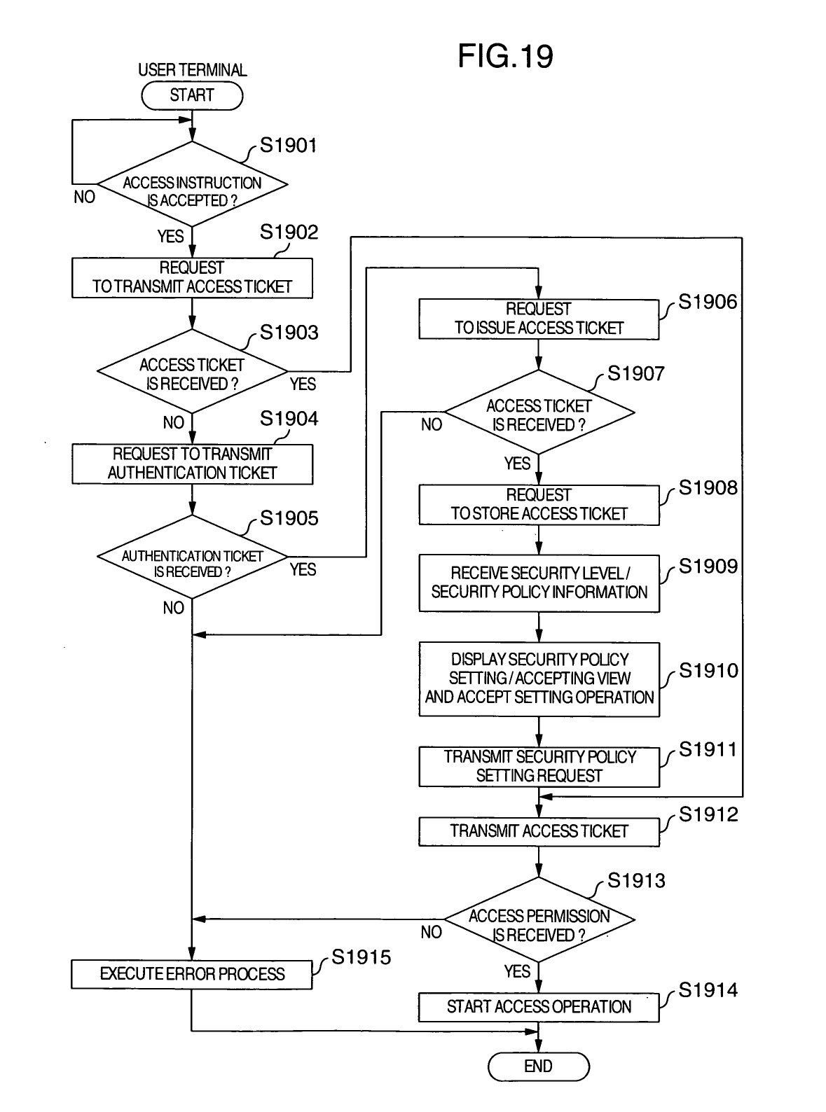

FIG. 19 is a flowchart for explaining operations of the user terminal 80. When the HT 90 is mounted on the user terminal 80, this user terminal 80 establishes a communication path between the HT 90 and the own user terminal 80. Otherwise, when the user terminal 80 is approached to the HT 90, this user terminal 80 establishes a communication path between the own user terminal 80 and the HT 90 by way of the short distance wireless communication such as the infrared communication. Also, in the case that the user terminal 80 belongs to a management area of the wireless AP 701, the user terminal 80 establishes a communication path between this wireless AP 701, and the user terminal 80. Then, when both the communication paths are established, this flow operation is commenced. It should also be understood that as to the communication paths with respect to the HT 90 and the wireless AP 701 security has been secured by mutually authenticating the HT 90 any the wireless AP 701 with respect to the user terminal 80.

Now, description will be made of operations executed in such a case that a room existing person accesses an electronic appliance employed in the room area 10 by using the user terminal 80 owned by this room existing person.

First, when the main control unit 806 accepts an access instruction from the room existing person via the input apparatus 803 (Step S1901), the main control unit 806 transmits an access ticket transmitting request via the wireless communication unit 801 to the HT 90 (Step S1902). This access instruction is issued to such an electronic appliance corresponding to the structural element 70 which belongs to the room area 10 constituted on a floor where the room existing person is located. Then, if the main control unit 806 receives an access ticket from the HT 90 (“YES” in Step S1903), then the process operation is advanced to Step S1912. On the other hand, if the main control unit 806 receives such an error message that the access ticket has not yet been stored from the HT 90 (“NO” in Step S1903), then the main control unit 806 transmits an authentication ticket transmitting request via the wireless communication unit 801 to the HT 90 (Step S1904). Thereafter, the process operation is advanced to Step S1905.

In Step S1905, if the main control unit 806 receives such an error message that the authentication ticket has not yet been stored from the HT 90, then the main control unit 806 notifies such a fact that the room entering person is not authenticated to the room existing person by displaying an error message on the display unit 804 (Step S1915). Thereafter, this flow operation is ended. On the other hand, if the main control unit 806 receives the authentication ticket from the HT 90, then the main control unit 806 transmits an access ticket issuing request in conjunction with this authentication ticket via the wireless LANIF unit 802 to a structural electronic appliance as an access subject (Step S1906). Then, when the main control unit 806 receives an access ticket from the structural electronic appliance of the access subject (“YES” in Step S1907), the process operation is advanced to Step S1908. On the other hand, when the main control unit 806 receives an error message from the structural electronic appliance of the access subject (“NO” in Step S1907), the main control unit 806 notifies such a fact that the authentication ticket is not justified (for instance, time limit is expired) in such a manner that an error message is displayed on the display unit 804 (Step S1915). Thereafter, this flow operation is accomplished.

In Step S1908, the main control unit 806 transmits the received access ticket via the wireless communication unit 801 to the HT 90 (Step S1908). Next, the main control unit 806 receives both a security level of the room area 10 and information of a security policy item from the structural electronic appliance of the access subject via the wireless LANIF unit 802 (Step S1909). The security level of the room area 10 is constructed on the floor where a room existing person is located. The security policy item is settable to the structural electronic appliance of the access subject. Then, the main control unit 806 displays a setting accept view of the security policy which contains the above-described information on the display unit 804, and accepts setting of the security policy from the room existing person (Step S1910).

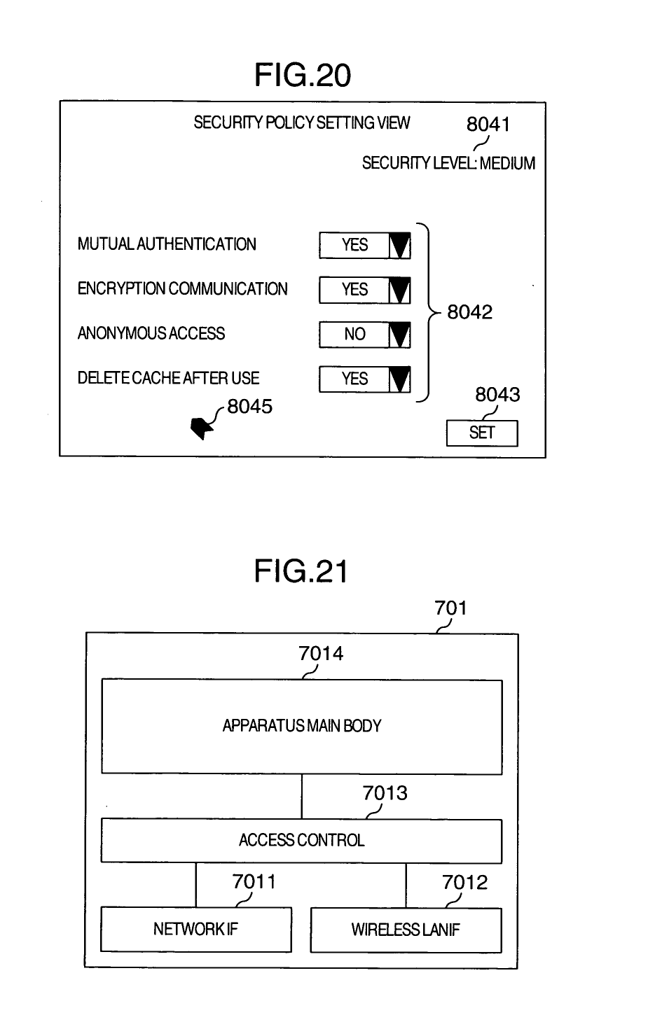

FIG. 20 illustratively shows an example of the security policy setting/accepting view displayed on the display unit 804 of the user terminal 80. As indicated in this drawing, the security policy setting/accepting view contains a display column 8041, an instruction input column 8042, and a setting button 8043. The display column 8041 displays thereon the security level of the room area 10 constituted on the floor where the room existing person is located. The instruction input column 8042 is used to accept such a condition as to whether or not each of security policy items settable to the structural electronic appliance of the access subject is set. The room existing person manipulates a cursor 8045 via the input unit 803 so as to input as to whether or not each of these items is set to the instruction input column 8042. It should also be noted that such an indicator capable of displaying the security level of the room area 10 may be separately provided on the user terminal 80 independent from the display unit 804.

In the security policy setting/accepting view shown in FIG. 20, if the cursor 8045 is manipulated by the room existing person via the input unit 803 and the setting button 8043 is selected, then the main control unit 806 transmits setting/or not conditions entered into the instruction input column 8042 as setting information of the respective security policy items via the wireless LANIF unit 802 to the structural electronic appliance of the access subject. Then, the main control unit 806 waits that a completion of setting the security policy information is notified from the structural electronic appliance of the access subject (Step S1911). Then, the process operation is advanced to Step S1912.

In Step S1912, the main control unit 806 transmits an access ticket via the wireless LANIF unit 802 to the structural electronic appliance of the access subject. Then, if the main control unit 806 receives an access permission from the structural electronic appliance of the access subject (“YES” in Step S1913), then the main control unit 806 commences an access operation to the structural electronic appliance of the access subject (Step S1914). On the other hand, if the main control unit 806 receives an error message from the structural electronic appliance of the access subject (“NO” in Step S1913), the main control unit 806 notifies such a fact that the access ticket is not justified (for instance, time limit is expired) in such a manner that an error message is displayed on the display unit 804 (Step S1915). Thereafter, this flow operation is accomplished.

Returning back to FIG. 1, the description is continued. Each of the electronic appliances corresponding to the structural element 70 employed in the room area 10 performs an intermediate process operation of issuing an access ticket which is carried out between the related authentication control apparatus 60 and the user terminal 80. Also, each of the electronic appliances controls an access to the relevant electronic appliance which is carried out by the user terminal 80 with employment of the access ticket.

FIG. 21 is a schematic diagram for representing an internal arrangement of an electronic appliance corresponding to the structural element 70. In this example, a structure of the wireless AP 701 is exemplified. As represented in this drawing, the wireless AP 701 contains a network IF unit 7011, a wireless LANIF unit 7012, an access control unit 7013, and an apparatus main body 7014 which corresponds to a portion for realizing the original function of the wireless AP 701. In such a case that this wireless AP 701 corresponds to a printer 702, a scanner 703, and a file server 704, the above-explained wireless LANIF unit 7012 is no longer required. The network IF unit 601 is employed so as to be communicated to the respective apparatus (authentication control apparatus 60, network appliance, information appliance) which constitute the internal network system of the building, and is connected via a network cable to the SWHUB 20. The wireless LANIF unit 7012 is employed so as to be wireless-communicated to a wireless LAN terminal (including user terminal 80). Then, the access control unit 7013 perfumes an intermediate process operation for issuing an access ticket, and also, an access limiting process operation from the user terminal 80. It should be understood that the access control unit 7013 may be carried out in a hardware manner by an integrated logic IC such as ASIC (Application Specific Integrated Circuit), or may be executed in a software manner by a computer such as a DSP (Digital Signal Processor).

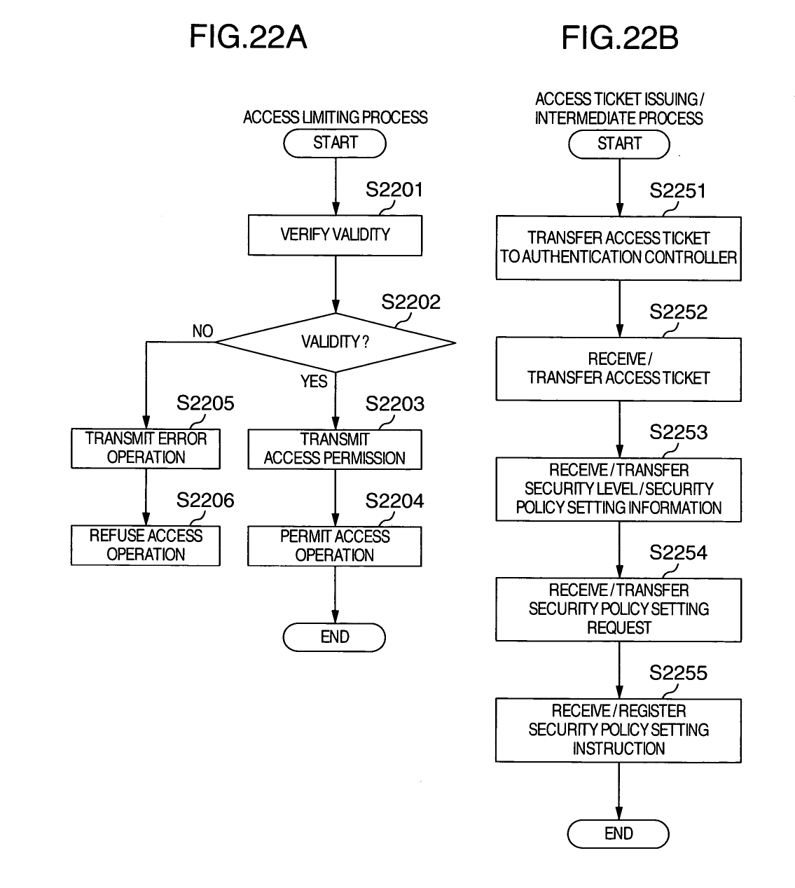

FIG. 22A to FIG. 22B are flowcharts for explaining operations of the access control unit 7013 of each of the electronic appliances which constitute the structural element 70. FIG. 22A indicates an operation flow as to the access limiting process operation. Then, FIG. 22B shows an operation flow as to the access ticket issuing process operation.

First, the access limiting process operation will now be explained with employment of FIG. 22A. This flow operation is commenced when the access control unit 7013 accepts an access request via either the network IF unit 7011 or the wireless LANIF unit 7012 from the user terminal 80.

The access control unit 7013 checks validity of an access ticket added to the received access request (step S2201). Concretely speaking, in such a case that the present date does not expire a validity term 6163 of the access ticket, and further, a signature verification of an electronic signature 6166 of the access ticket, the access control unit 7013 judges that the access ticket is justified. It should also be noted that while the access control unit 7013 owns signature verifying keys of the respective authentication control apparatus 60, this access control unit 7013 verifies the signature of the electronic signature 6166 of the access ticket by employing the signature verifying key which corresponds to the authentication control apparatus 60 of the issuing source 6162 of the access ticket.

Next, if the access control unit 7013 can confirm the validity of the access ticket (“YES” in Step S2202), then the access control unit 7013 transmits an access permission message to the user terminal 80 of the access request transmission source (Step S2203). Then, the access control unit 7013 permits this user terminal 80 to access the apparatus main body 7014 (Step S2204). In this case, if there is such a security policy which has been set in correspondence with a provisional ID 6161 of the access ticket whose justification has been confirmed, then this set security policy is applied to the access request issued from the user terminal 80.

On the other hand, when the access control unit 7013 cannot confirm the justification of the access ticket (“NO” in Step S2202), the access control unit 7013 transmits an error message to the user terminal 80 of the access request transmission source (Step S2205). Then, the access control unit 7013 refuses an access operation of this user terminal 80 with respect to the apparatus main body 7014 (Step S2206).

Next, description will be made of the intermediate process operation as to the access ticket issuing operation with employment of FIG. 22B. This flow operation is commenced when the access control unit 7013 accepts an access ticket issuing request via either the network IF unit 7011 or the wireless LANIF unit 7012 from the user terminal 80.

The access control unit 7013 transfers the received access ticket issuing request to the authentication control apparatus 60 which belongs to the same room area 10 as the own structural appliance in combination with the authentication ticket added to this request (Step S2251).

Next, when the access control unit 7013 receives an access ticket from the authentication control apparatus 60 as a response to the access ticket issuing request, the access control unit 7013 transfers this received access ticket to the user terminal 80 (Step S2252).

Next, when the access control unit 7013 receives both a security level of the same room area 10 as the own structural electronic appliance and information as to an item of a security policy settable to the own structural electronic appliance from the authentication control apparatus 60, the access control unit 7013 transfers these received security level and security policy to the user terminal 80 (Step S2253).

Next, when the access control unit 7013 receives a security policy setting request which contains the information of the security policy to be set to the own structural electronic appliance from the user terminal 80, the access control unit 7013 transfers this received security policy setting request to the authentication control apparatus 60 (Step S2254). Then, when the access control unit 7013 receives a security policy setting instruction from the authentication control apparatus 60, the access control unit 7013 sets this security policy setting instruction to the own structural appliance, and further, transmits such a notification that setting of the security policy has bee accomplished to the user terminal 80. This security policy setting instruction contains both a provisional ID 6161 of the access ticket and information as to the security policy to be set. Thereafter, the access control unit 7013 applies this security policy to the access request in connection with this access ticket (Step S2255).

Next, description will be made of information process operations executed among the HT 90, the authentication control apparatus 60, and the authentication apparatus 50 when an authentication ticket is issued.

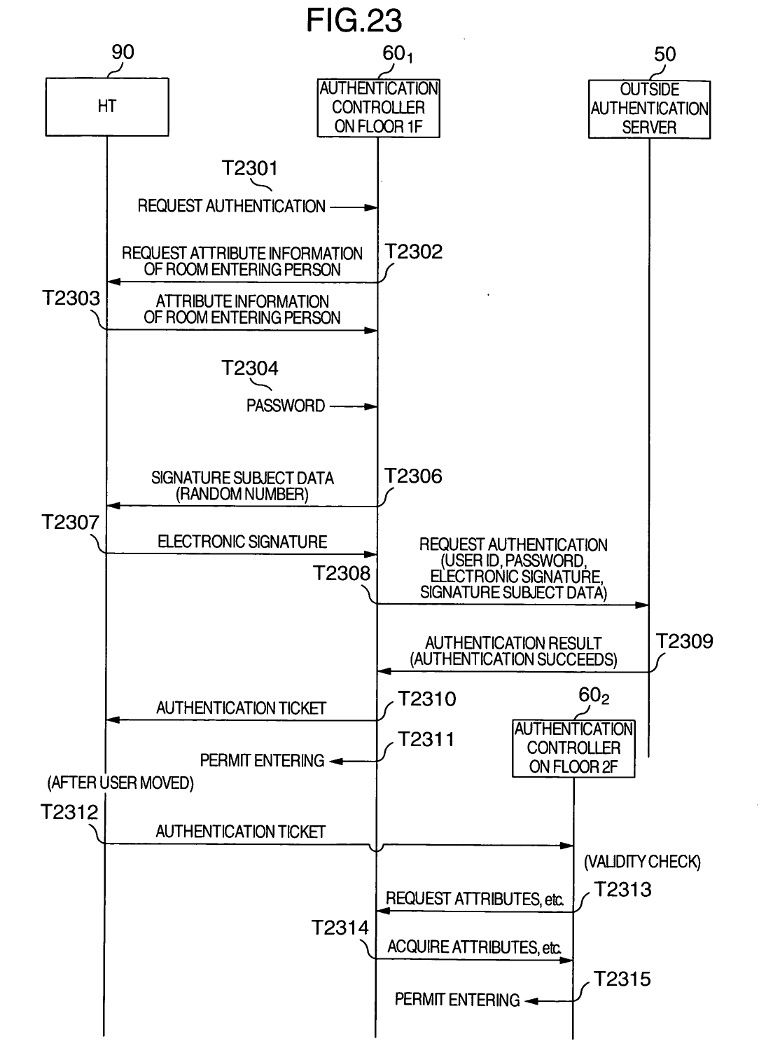

FIG. 23 is a diagram for indicating an information flow operation executed among the HT 90, the authentication control apparatus 60, and the authentication apparatus 50 when the authentication ticket is issued.

When the authentication control apparatus 60₁ on floor 1F accepts an authentication request from a room entering person (T2301), the authentication control apparatus 60₁ commences a flow operation shown in FIG. 11. Then, the authentication control apparatus 60₁ transmits a request for transmitting attribute information of a room entering person to the HT 90 in order to determine a trust level of the room entering person (T2302).

When the HT 90 receives the room-entering-person attribute information transmitting request from the authentication control apparatus 60₁, the HT 90 checks as to whether or not an authentication ticket has been stored in the flowchart shown in FIG. 17. In this example, it is so assumed that the authentication ticket has not yet been stored. In this case, the HT 90 sends the attribute information of the room entering person to the authentication control apparatus 60₁ (T2303).

In such a case that the authentication control apparatus 60₁ does not receive the authentication ticket from the HT 90, the authentication control apparatus 60₁ determines an authentication level based upon both the trust level determined by employing the attribute information of the room entering person and the security level of the room area 10₁, and then, specifies an authenticating method corresponding to the determined authentication level. In this example, it is so assumed that “password authentication+electronic signature authentication” is specified. In this case, the authentication control apparatus 60₁ requires a password request to the room entering person, and then, accepts the input of the password from the room entering person (T2304). Furthermore, the authentication control apparatus 60₁ produces signature subject data, and then, transmits this signature subject data to the HT 90 in order to request an electronic signature (T2306).

When the HT 90 receives the electronic signature request from the authentication control apparatus 60₁, the HT 90 produces an electronic signature of the signature subject data which has been added to this electronic signature request, and then transmits the produced electronic signature to the authentication control apparatus 60₁ (T2307).

When all of such authentication information (namely, password, electronic signature, and signature subject data) required for the specific authenticating method are collected, the authentication control apparatus 60₁ produces an authentication request which contains all of the above-explained authentication information, the user ID contained in the room-entering-person attribute information, and the designation of the authenticating method, and then transmits the authentication request to the authentication apparatus 50 (T2308).

When the authentication apparatus 50 receives the authentication request from the authentication control apparatus 60₁, the authentication apparatus 50 executes an authentication process operation in accordance with the flowchart shown in FIG. 15. Then, the authentication apparatus 50 transmits the authentication result to the authentication control apparatus 50 (T2309). In this example, it is so assumed that such an authentication result indicative of “success” is transmitted to the authentication control apparatus 50.

When the authentication control apparatus 60₁ receives the authentication result indicative of “success” from the authentication apparatus 50, this authentication control apparatus 60₁ produces an authentication ticket, and then, transmits the produced authentication ticket to the HT 90 (T2310). Then, the authentication control apparatus 60₁ permits the room entering person to enter the room area 10₁ (T2311).

Thereafter, when the room entering person who entered the room area 10₁ goes out of the room area 10₁, and then is going to enter the room area 10₂ on the floor 2F, HT90 of the room entering person transmits the authentication ticket held therein to the authentication control apparatus 60₂ (T2312). The authentication control apparatus 60₂ checks validity of the authentication ticket sent. If the authentication ticket is valid, the authentication control apparatus 60₂ requests the attribute information of the room entering person and the security policy to the authentication control apparatus 60₁ (T2313). In response to the request, the authentication control apparatus 60₁ sends the attribute information and the security policy to the authentication control apparatus 60₂ (T2314). After acquiring the attribute information and the security policy, the authentication control apparatus 60₂ permits the room entering person to enter the room area 10₂ (T2315).

Next, description will be made of information process operations executed among the HT 90, the user terminal 80, the structural electronic appliances 701 to 703 (will be referred to as “70x”), and the authentication control apparatus 60 when an access ticket is issued.

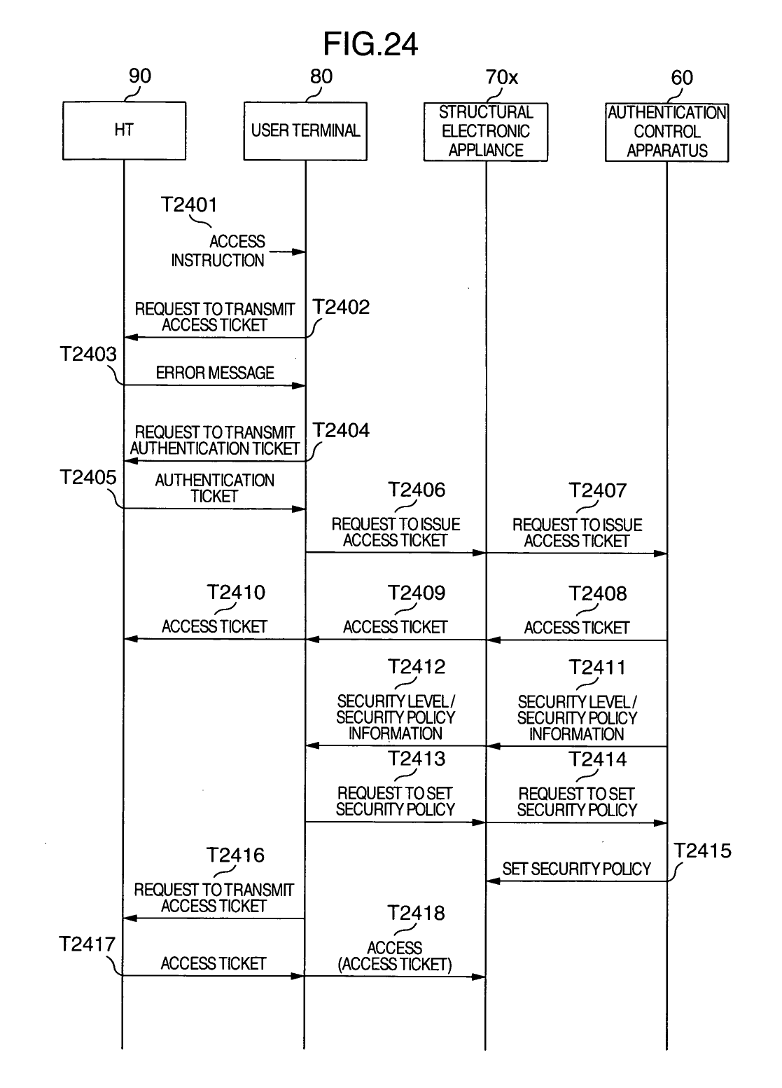

FIG. 24 is a diagram for representing an information flow operation executed among the HT 90, the user terminal 80, the structural electronic appliance 70x, and the authentication control apparatus 60 when the access ticket is issued.

When the user terminal 80 accepts an access instruction from an owner to the structural appliance 70x (T2401), the user terminal 80 commences the flow operation shown in FIG. 19. Then, the user terminal 80 transmits an access ticket transmitting request containing a designation of identification information of the structural electronic appliance to the HT 90 (T2402).

When the HT 90 receives the access ticket transmitting request from the user terminal 80, the HT 90 checks whether or not an access ticket with respect to the structural electronic appliance 70x has been stored in accordance with the flow operation shown in FIG. 17. In this example, it is so assumed that the access ticket has not yet been stored. In this case, the HT 90 sends an error message to the user terminal 80 (T2403).

If the user terminal 80 receives the error message from the HT 90, then this user terminal 80 further sends an authentication ticket transmission request to the HT 90 (T2404). Upon receipt of this authentication ticket transmitting request, the HT 90 transmits the authentication ticket to the user terminal 80 (T2405).

Then, when the user terminal 80 receives the authentication ticket from the HT 90, this user terminal 80 sends an access ticket issuing request containing this authentication ticket to the structural electronic appliance 70x corresponding to the access request (T 2406). Thereafter, the structural electronic appliance 70x transfers the access ticket issuing request received by the user terminal 80 to the authentication control apparatus 60 which belongs to the same room area 10 as the own structural electronic appliance in accordance with the flow operation of FIG. 22B (T2407).

When the authentication control apparatus 60 receives the access ticket issuing request from the structural appliance 70x, the authentication control apparatus 60 commences the flowchart of FIG. 12. Then, after the authentication control apparatus 60 has confirmed justification of the authentication ticket which is contained in the access ticket issuing request, the authentication control apparatus 60 produces an access ticket, and then transmits the produced access ticket to the structural electronic appliance 70x (T2408). This structural electronic appliance 70x corresponds to a transfer source of the access ticket issuing request. This access ticket is transferred via the structural electronic appliance 70x and the user terminal 80, and is finally stored in the HT 90 (T2409 and T2410).

Next, the authentication control apparatus 60 transmits both a security level of the room area 10 and information of a security policy to the structural electronic appliance 70x (T2411). This security policy information is settable to the structural electronic appliance 70x which corresponds to the transfer source of the access ticket issuing request. The structural electronic appliance 70x transmits all of the above-explained information to the user terminal 80 (T2412).

When the user terminal 80 receives via the structural electronic appliance 70x both the security level of the room area 10 and the security policy information settable to this structural electronic appliance 70x, the user terminal 80 displays such a security policy setting view as shown in FIG. 20, and accepts setting of a security policy from the room existing person. The accepted security policy is transferred via the structural electronic appliance 70x to the authentication control apparatus 60 (T2413 and T2414).

Next, when the authentication control apparatus 60 receives the security policy from the structural electronic appliance 70x, the authentication control apparatus 60 sets this received security policy to the structural electronic appliance 70x in correspondence with the provisional ID of the access ticket (T2415).

Thereafter, the user terminal 80 transmits an access ticket transmitting request containing a designation of identification information of the structural electronic appliance 70x to the HT 90 (T2416). Then, when the user terminal 80 receives an access ticket with respect to the structural electronic appliance 70x from the HT 90 (T2417), the user terminal 80 transmits this access ticket to the structural electronic appliance 70x so as to issue an access with respect to the structural electronic appliance 70x (T2418). As a result, the structural electronic appliance 70x controls the access operation in accordance with the flow operation of FIG. 22A.

As previously explained, the authentication control system/method according to one embodiment of the present invention have been described.

In accordance with this embodiment, the authentication control apparatus 60 determines the authentication level based upon both the trust level of the room entering person in response to the attribute information of the room entering person, and the security level of the room area 10 which is tried to be used by this room entering person, which have been stored in the HT 90. Thus, the authenticating method corresponding to this determined authentication level is applied to the authenticating operation for the room entering person. As a consequence, the determination of the authenticating method of this room entering person can be adapted to the content of the room area.

Also, in accordance with this embodiment, as indicated by a broken line of FIG. 1, when the room entering person is moved from the first room area 10₁ to the second room area 10₂, in such a case that the authentication level of the authentication ticket of this user, which has been issued by the authentication control apparatus 60 belonging to the first room area 10₁ in order to utilize this first room area 10₁, is higher than the authentication level required in the authenticating operation, which has been determined by the authentication control apparatus 60 belonging to the second room area 10₂, in order to utilize the second room area 10₂, the authentication control apparatus 60 does not again request the authentication apparatus 50 to execute the authenticating operation. As a consequence, a so-called “single sign-on” can be realized in which the utilization of the plural room areas (services) 10 is made by performing the authenticating operation by the authentication apparatus 50 one time.

Also, in accordance with this embodiment, the authentication control apparatus 60 issues the access ticket for allowing the access operation with respect to the electronic appliance corresponding to the structural element 70 based upon the authentication ticket provided from the user terminal 80. Then, the user terminal 80 accesses the structural electronic appliance of the structural element 70 by employing this issued access ticket. As a consequence, in order to use the respective structural electronic appliances, there is no need to make the authentication request with respect to the authentication apparatus 50 every time each of these structural electronic appliances is utilized. Therefore, a so-called “single sign-on” can be realized by which the utilization as to a plurality of structural electronic appliances (services) can be carried out by performing the authenticating operation by the authentication apparatus 50 one time.

It should be understood that the present invention is not limited only to the above-described embodiment, but may be modified within the technical scope of the present invention.

For example, in the above-described embodiment, such a case has been explained. That is, the room floor 10 is constructed in the unit of the floor. Then, the open/close control unit 604 of the door/gate is provided with the authentication control apparatus 60, while the door/gate restrict the entry of the room entering person into the floor where the room area 10 to which this authentication control apparatus 60. However, the present invention is not limited only to the above-described case. For instance, the room area 10 may be alternatively constructed, while such a physical condition as a floor and a room area is employed as the unit, or such a virtual space as an electronic conference room is used as the unit.

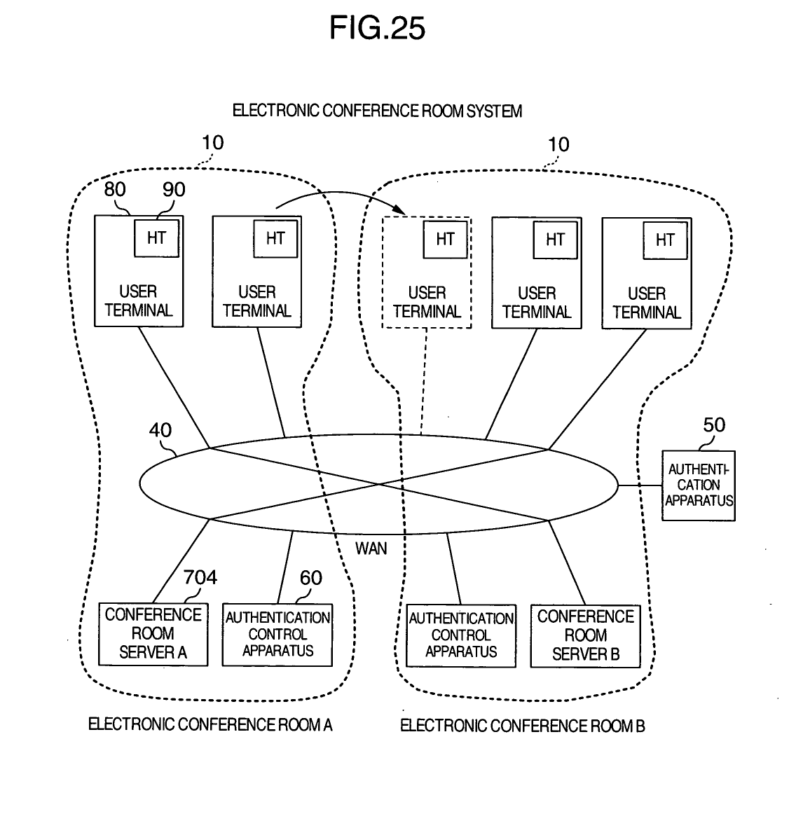

FIG. 25 illustratively indicates an example of such a case that the present invention has been applied to an electronic conference room system. In this example, while the room area 10 is constructed every electronic conference room 10, each of the electronic conference rooms 10 contains an authentication control apparatus 60, and a conference room server 704 which is equivalent to the electronic appliance of the structural element. In the case that a room entering person (user) uses a room area 10 of a desirable electronic conference room, the authentication control apparatus 60 belonging to this room area 10 executes the flow operation shown in FIG. 11 (note that open/close control operation of Step S1120 is not required). Then, in the case that the room entering person accesses the conference room server 704 of this room area 10, the authentication control apparatus 60 belonging to this room area 10 executes the flow operation indicated in FIG. 12.

Similarly, in the example shown in FIG. 25, the authentication control apparatus 60 determines an authentication level based upon both a trust level of this room entering person corresponding to the attribute information of the room entering person stored in the HT 90, and also, a security level of the room area 10 (electronic conference room) which is tried to be used by this room entering person, and then, applies an authenticating method corresponding to this authentication level to authentication of this room entering person. Also, as indicated by an arrow of FIG. 25, when the room entering person is moved from the first room area 10 (electronic conference room A) to the second room area 10 (electronic conference room B), in such a case that an authentication level of an authentication ticket of this room entering person which has been issued by the authentication control apparatus 60 belonging to the first room area 10 in order to utilize this first room area 10 is higher than such an authentication level which has been determined by the authentication control apparatus 60 belonging to the second room area 10 and is required for executing an authenticating operation so as to utilize this second room area 10, a request for authentication is not again made with respect to the authentication apparatus 50. As a consequence, a so-called “single sign-on” can be realized by which the utilizations as to a plurality of room area 10 (electronic conference rooms) can be carried out by performing the authenticating operation by the authentication apparatus 50 one time.

Also, in the above-described embodiments, the below-mentioned case has been explained. That is, the storing operations of various sorts of information as to the attribute information of the room entering person, the authentication ticket, and the access ticket have been carried out by the HT 90, and also, the producing operation of the electronic signature has been carried out by the HT 90. Alternatively, the storing operations of the information and the producing operation of the electronic signature may be alternatively carried out by the user terminal 80. Furthermore, the function as the authentication apparatus 50 may alternatively be applied to any one of the authentication control apparatus 60.

It should be further understood by those skilled in the art that although the foregoing description has been made on embodiments of the invention, the invention is not limited thereto and various changes and modifications may be made without departing from the spirit of the invention and the scope of the appended claims.

1. An authentication control apparatus for determining an authenticating method of a room entering person who is trying to enter an area where one or more structural elements are present by employing a storage medium into which attribute information of said room entering person has been stored, comprising:
a structural element information acquiring unit for acquiring a security level via a network, which has been set to each of the structural elements which are presently located within said area;
an attribute information acquiring unit for acquiring the attribute information of said room entering person from said storage medium;
a security level determining unit for determining a present security level of said area by employing the security levels of said respective structural elements acquired by said structural element information acquiring unit;
a trust level determining unit for determining a present trust level of said room entering person by employing the attribute information of said room entering person acquired by said attribute information acquiring unit; and
an authenticating method determining unit for determining an authenticating method of said room entering person in a manner that at least one authenticating method is selected from a plurality of authenticating methods by employing said determined present security level of the area and said determined present trust level of said room entering person.

2. An authentication control apparatus as claimed in claim 1, wherein:
if a total number of structural elements which are present in said area is increased/decreased, then the present security level of said area which is determined by said security level determining unit is increased/decreased.

3. An authentication control apparatus as claimed in claim 1, wherein:
the structural elements present within said area contain a person who is located in said area, and to which a predetermined security level has been set.

4. An authentication control apparatus as claimed in claim 1, wherein:
said attribute information of said room entering room contains two or more items as to a user ID (identification) of said room entering person, a status of said room entering person, a belonging section of said room entering person, a use frequency of said area by said room entering person, and an access place to said area by said room entering person.

5. An authentication control apparatus as claimed in claim 1, wherein:
said area corresponds to a virtual network which is constructed on the network.

6. An authentication control apparatus as claimed in claim 1, wherein:
authentication information which is used to authenticate said room entering person has been stored in said storage medium; and
said authentication control apparatus further comprises:
an authentication information acquiring unit for acquiring, from said storage medium and/or said room entering person, authentication information which is required in an authenticating operation by the authenticating method determined by said authenticating method determining unit;
an authentication requiring unit for transmitting an authentication request containing the authentication information acquired by said authentication information acquiring unit to an authentication apparatus which is connected via said network to said authentication control apparatus, and for receiving an authentication result from said authentication apparatus; and
an authentication ticket issuing ticket for producing an authentication ticket in which an authentication level corresponding to the authenticating method determined by said authenticating method determining unit has been designated in a case that the authentication result received by said authentication requesting unit from said authentication apparatus indicates a success of the authenticating operation, and for storing said produced authentication ticket into said storage medium.

7. An authentication control apparatus as claimed in claim 1, wherein:
in a case that an authentication ticket of another area has been stored in said storage medium, said attribute information acquiring unit acquires the authentication ticket of said another area in combination with the attribute information of said room entering person; and
in a case that the authentication ticket of said another area has been acquired by said attribute information acquiring unit, said authenticating method determining unit determines an authentication level of said room entering person by employing both the present security level of said area which has been determined by said security level determining unit and the present trust level of said room entering person which has been determined by said trust level determining unit; and
in a case that said determined authentication level is lower than said authentication level designated by said authentication ticket of said another area, a re-authenticating operation of said room entering person is omitted.

8. An authentication control apparatus as claimed in claim 1, wherein:
said one or more structural elements include at least one appliance connected to said network,
said authentication control apparatus further comprises:
an access ticket issuing unit for producing an access ticket which indicates a right by which said room entering person accesses said appliance, and for storing said produced access ticket into said storage medium; and
a justification checking unit operated in such a manner that when said authentication ticket has been stored in said storage medium, said justification checking unit checks justification of said stored authentication ticket, and wherein:
when said justification checking unit judges that said authentication ticket stored in said storage medium is justified, said justification checking unit instructs said access ticket issuing unit to produce the access ticket.

9. An authentication control apparatus as claimed in claim 8, wherein:
said authentication control apparatus further comprises:
a security policy accepting unit for accepting a security policy from said room entering person, which is applied to a communication with said structural element, in a case that said access ticket issuing unit produces the access ticket and then stores the produced access ticket into said storage medium, and
a security policy setting unit for setting the security policy accepted by said security policy accepting unit to said structural element in correspondence with the access ticket produced by said access ticket issuing unit.

10. An authentication control apparatus as claimed in claim 1, further comprising:
an authentication unit for performing a user authentication operation in accordance with the authenticating method determined by said authenticating method determining unit.

11. An authentication control method for determining an authenticating method of a room entering person who is trying to enter an area where either one or more structural elements are present by employing a storage medium into which attribute information of said room entering person has been stored, comprising:
a structural element information acquiring step for acquiring a security level via a network, which has been set to each of the structural elements which are presently located within said area;
an attribute information acquiring step for acquiring the attribute information of said room entering person from said storage medium;
a security level determining step for determining a present security level of said area by employing the security levels of said respective structural elements acquired in said structural element information acquiring step;
a trust level determining step for determining a present trust level of said room entering person by employing the attribute information of said room entering person acquired in said attribute information acquiring step; and
an authenticating method determining step for determining an authenticating method of said room entering person in a manner that at least one authenticating method is selected from a plurality of authenticating methods by employing both said determined present security level of the area and said determined present trust level of said room entering person.

12. A computer readable storage medium for storing thereinto a program which is used to execute, in a computer, an authentication control method for determining an authenticating method of a room entering person who is trying to enter an area where one or more structural elements are present by employing a hardware token into which attribute information of said room entering person has been stored, wherein:
said authentication control method is comprised of:
a structural element information acquiring step for acquiring a security level via a network, which has been set to each of the structural elements which are presently located within said area,
an attribute information acquiring step for acquiring the attribute information of said room entering person from said hardware token,
a security level determining step for determining a present security level of said area by employing the security levels of said respective structural elements acquired in said structural element information acquiring step,
a trust level determining step for determining a present trust level of said room entering person by employing the attribute information of said room entering person acquired in said attribute information acquiring step, and
an authenticating method determining step for determining an authenticating method of said room entering person in such a manner that at least one authenticating method is selected from a plurality of authenticating methods by employing both said determined present security level of the area and said determined present trust level of said room entering person.

13. A program stored in a computer readable storage medium to determine an authenticating method of a room entering person who is trying to enter an area where one or more structural elements are present by employing a hardware token into which attribute information of said room entering person has been stored, comprising:
a structural element information acquiring step for acquiring a security level via a network, which has been set to each of the structural elements which are presently located within said area;
an attribute information acquiring step for acquiring the attribute information of said room entering person from said hardware token;
a security level determining step for determining a present security level of said area by employing the security levels of said respective structural elements acquired in said structural element information acquiring step;
a trust level determining step for determining a present trust level of said room entering person by employing the attribute information of said room entering person acquired in said attribute information acquiring step; and
an authenticating method determining step for determining an authenticating method of said room entering person in a manner that at least one authenticating method is selected from a plurality of authenticating methods by employing both said determined present security level of the area and said determined present trust level of said room entering person.
